(19) United States
(12) Patent Application Publication
(10) Pub. No.: US 2007/0143186 A1
(43) Pub. Date: Jun. 21, 2007

(54) Systems, apparatuses, methods, and computer program products for optimizing allocation of an advertising budget that maximizes sales and/or profits and enabling advertisers to buy media online

(76) Inventors: Jeff Apple, Malibu, CA (US); Lehmann Li, Studio City, CA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/640,225

(22) Filed: Dec. 18, 2006

Related U.S. Application Data
(60) Provisional application No. 60/751,627, filed on Dec. 19, 2005.

(51) Int. Cl. G06Q 30/00

(52) U.S. Cl. 705/14

(57) ABSTRACT

A system, apparatus, methods, and computer program products enabling an advertiser to increase or maximize sales and/or profits of a company, brand, and/or product by determining the optimum size of an advertising budget and/or optimizing the allocation of an advertising budget to those media channels, operators within any given media channel, program/page provided by any given operator, and/or space within any given program/page, which generates the highest ratio of sales on invested capital, maximum sales, and/or maximum profits. A system and method of enabling an advertiser to input online the parameters of an advertising campaign, including, but not limited to: the product category, the budget, the characteristics of the target customer, and the desired timing; generating an optimum allocation of said budget which generates the highest ratio of sales on invested capital, maximum sales, and/or maximum profits; enabling operators to offer online the availability of advertisement inventory on their programs/pages and/or spaces; automating the process of determining the optimum size of an advertising budget and/or optimizing the allocation of an advertising budget; integrating advertising planning and purchasing into an advertiser's enterprise resource planning system; enabling an advertiser to bid online to advertise on said programs/pages and/or spaces; and matching advertisers and operators to execute the purchase of said advertisement inventory.

### CROSS REFERENCE TO RELATED APPLICATIONS

This application claims the benefit of U.S. Provisional Application No. 60/751,627, filed on Dec. 19, 2005, entitled “System, apparatus, and methods optimizing allocation of an advertising budget that maximizes sales and/or profits and enabling advertisers to buy media online,” which is incorporated by reference herein in its entirety. The application is also related to Disclosure Document, Ser. No. 590,582, filed on Nov. 23, 2005, entitled “System and methods of optimizing allocation of an advertising budget that maximizes sales and/or profits and enabling advertisers to buy media online,” which is incorporated by reference herein in its entirety.

### FIELD OF THE INVENTION

The present invention relates to systems, apparatuses, methods, and computer program products for optimizing an advertising budget and enabling the efficient bid for, offer, and purchase of advertisement inventory. In particular, the present invention relates to a system, apparatus, methods, and computer program products of determining the optimum size of an advertising budget and optimizing the allocation of an advertising budget among media channels to maximize the sales and/or profits of a company, brand, and/or product promoted in the advertisement, automating said methods and integrating them with an advertiser's enterprise resource planning system, and enabling advertisers and operators to bid for, offer, and execute the placement of advertisements.

### BACKGROUND OF THE INVENTION

Advertisers and/or media planning and/or buying firms typically allocate advertising budgets among media channels utilizing a variety of methods. These methods range from highly qualitative approaches to highly quantitative approaches.

However, even the highly quantitative methods typically allocate advertising budgets among media channels that maximizes the number of consumers viewing the advertisement.

The problem with maximizing the number of consumers viewing an advertisement is that there is not necessarily a correlation between the number of consumers viewing an advertisement and the number of consumers buying or the value of consumer purchases of the product promoted in the advertisement.

There are some media channels for which an advertiser can measure directly the sales or other benefits resulting from the purchasing of an advertisement. For example, an advertiser placing an advertisement on Internet search engines that charge on a cost-per-click (CPC) basis can measure the advertisement effectiveness.

An advertiser can measure its costs by calculating the product of the number of click-throughs and CPC. An advertiser can measure its benefits, because the advertiser can determine the search engine through which a consumer visited the web site of the advertiser and measure the sales resulting from said consumer's click-through.

There are methods that compare advertisement effectiveness across different web sites or search engines. For example, a third party can measure the sales resulting from a consumer's click-through at a given web site or search engine and compare the advertisement effectiveness across different web sites or search engines. Such data can enable an advertiser to determine which web sites or search engines can generate higher sales and could increase the amount said advertiser is willing to pay to purchase advertisement inventory on said web sites or search engines. However, these methods do not teach how an advertiser can utilize such data to optimize the allocation of its advertising budget among different web sites or search engines. Also, these methods do not enable an advertiser to compare the effectiveness of advertisements across media channels other than the Internet and optimize the allocation of its advertising budget among all media channels.

There are methods enabling an advertiser to maximize, inter alia, the number of impressions, click-throughs, or sales resulting from advertisements purchased on the Internet. However, advertisers allocate the vast majority of their advertising budgets among media channels for which there are not effective means of measuring advertisement effectiveness. Without such means of measuring the advertisement effectiveness of media channels, in general, and individual programs/pages or spaces within individual programs/pages, in particular, an advertiser cannot optimize the allocation of its advertising budget to maximize the sales and/or profits for a given advertisement.

### SUMMARY OF THE INVENTION

The present invention includes a system, apparatus, and methods of enabling an advertiser to increase or maximize sales and/or profits of a company, brand, and/or product by determining the optimum size of an advertising budget and/or optimizing the allocation of an advertising budget to those media channels, operators within any given media channel, program/page provided by any given operator, and/or space within any given program/page, which generates the highest ratio of sales on invested capital, maximum sales, and/or maximum profits.

The present invention includes:

First, a system, apparatus, method, and computer program product of enabling an advertiser to increase or maximize sales and/or profits of a company, brand, and/or product by collecting data on the effectiveness of any given media channel, operator, program/page, and/or space, collecting data on the cost of any given advertisement inventory, collecting data on any costs of an advertiser that are affected by either the size of an advertising budget and/or the allocation of an advertising budget among any given advertisement inventory, and applying an algorithm to determine the optimum size of an advertising budget and/or the optimum allocation of an advertising budget.

Second, a system, method, and computer program product of determining automatically the optimum size of an advertising budget and/or optimize automatically the allocation of an advertising budget to maximize sales and/or profits by linking to hardware, software, and/or databases of a sales measurement system, operators, and advertisers.

Third, a system, method, and computer program product for integrating: (a) software, application, database, and/or computer program product determining the size of an advertising budget, the allocation of an advertising budget, and/or the type of advertisements produced and purchased; with (b) the other programs or applications of an Advertiser.

Fourth, a system, method, and computer program product of enabling an advertiser to input online the parameters of an advertising campaign, including, but not limited to: the product category, the budget, the characteristics of the target customer, and the desired timing; generating an optimum allocation of said budget which generates the highest ratio of sales on invested capital, maximum sales, and/or maximum profits; enabling operators to offer online the availability of advertisement inventory on their programs/pages and/or spaces; enabling an advertiser to bid online to advertise on said programs/pages and/or spaces; and matching advertisers and operators to execute the purchase of said advertisement inventory.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 illustrates how a typical media planning or media buying firm views the relationships among an advertiser, the different media channels and operators, and the consumer.

FIG. 2 illustrates how a media planning/buying firm should consider viewing how a consumer responds to viewing an advertisement.

FIG. 3 is a block diagram illustrating the structural and functional interrelationships of an exemplary computer programmed to determine the optimum size of an advertising budget and allocate optimally an advertising budget.

FIG. 4 is a block diagram illustrating the structural and functional interrelationships of an exemplary system of advertisers, operators, and third parties enabling the determination of an optimum size of an advertising budget and optimum allocation of an advertising budget.

FIG. 5 is a flow chart of one embodiment of the present system optimizing allocation of an advertising budget considering only the cost to purchase advertisement inventory.

FIG. 6 is a flow chart of one embodiment of the present system optimizing allocation of an advertisement budget considering the cost to purchase advertisement inventory and other costs of an advertiser.

FIG. 7 is a block diagram illustrating the structural and functional interrelationships of an exemplary system of the present invention connecting with the hardware, software, and/or databases of an advertiser to allocate automatically an advertising budget.

FIG. 8 is a block diagram illustrating the structural and functional interrelationships of an exemplary system of the present invention connecting an advertisement planning application with an enterprise resource planning and other applications and databases of an advertiser.

FIG. 9 is an exemplary web page enabling an advertiser to input certain parameters of an advertising campaign, which the present invention would utilize in determining the optimum allocation of an advertising budget among the different media channels, operators, programs/pages, and/or spaces.

FIG. 10 is a block diagram illustrating the structural and functional interrelationships of an exemplary system of advertisers, different media channels and operators, and third parties enabling online media buying.

### DETAILED DESCRIPTION OF THE INVENTION

The present invention is directed to systems, apparatuses, methods, computer program products, and combinations and sub-combinations thereof, of increasing or maximizing sales and/or profits of a company, brand, and/or product by determining the optimum size of an advertising budget and/or optimizing the allocation of an advertising budget to those media channels, operators within any given media channel, program/page provided by any given operator, and/or space within any given program/page, which generates the highest ratio of sales on invested capital, maximum sales, and/or maximum profits. The present invention includes a system and method of enabling an advertiser to input online the parameters of an advertising campaign, including, but not limited to: the product category, the budget, the characteristics of the target customer, and the desired timing; generating an optimum allocation of said budget which generates the highest ratio of sales on invested capital, maximum sales, and/or maximum profits; enabling operators to offer online the availability of advertisement inventory on their programs/pages and/or spaces; enabling an advertiser to bid online to advertise on said programs/pages and/or spaces; and matching advertisers and operators to execute the purchase of said advertisement inventory.

The present invention can produce the following useful, concrete, and tangible results:

Enable an advertiser to increase or maximize sales and/or profits, instead of maximize the number of impressions or the number of click-throughs as enabled in the prior art. Because the present invention can determine the optimum size of an advertising budget and/or optimize the allocation of an advertising budget to maximize profits, the present invention should maximize profits, while maximizing the number of impressions or click-throughs may or may not maximize profits.

Enable an advertiser to increase or maximize sales and/or profits in purchasing advertisement inventory across all media channels. Some prior art attempts to enable an advertiser to allocate Internet advertisement budget on the basis of conversions or sales. The present invention can enable an advertiser to increase or maximize sales and/or profits in purchasing advertisement inventory not just for Internet advertisements, but for all media channels.

Enable an advertiser to bid for and/or purchase advertisement inventory directly from operators online, instead of bid for and/or purchase advertisement inventory through existing means, which should lower costs of an advertiser to purchase advertisement inventory. The present invention can enable an advertiser to purchase advertisement inventory across all media channels.

Enable an advertiser to automate the process of determining the optimum size of an advertising budget and/or optimizing the allocation of an advertising budget among media channels, operators, programs/pages, and/or spaces to maximize sales and/or profits. The present invention can enable an advertiser to input certain parameters of an advertising campaign and then automatically determine the optimum size of an advertising budget and/or optimize the allocation of an advertising budget to maximize sales and/or profits. The present invention can link to hardware, software, and/or databases of an advertiser that contain data regarding said advertiser's costs and automatically determine the optimum size of an advertising budget and/or optimize the allocation of an advertising budget to maximize sales and/or profits.

The present invention defines the following terms:

Advertiser: Any entity that produces, distributes, and/or purchases an advertisement or funds said production, distribution, and/or purchase of an advertisement. An Advertiser can include, but is not limited to: the vendor of the goods or services advertised, an advertising agency that produces an advertisement on behalf of the Advertiser, a media planning and/or buying firm which purchases advertising on behalf of the Advertiser, or a third party. Where the present invention refers to Advertiser communicating with the internal hardware, software, and/or databases of a vendor of the goods or services advertised, the present invention limits the definition of Advertiser to said vendor.

Advertisement Inventory: Any unit of Program/Page and/or Space offered by an Operator for sale or lease to an Advertiser.

Consumer: While the present invention discusses a consumer in terms of a customer who views an advertisement and/or purchases a product for his or her consumption, the present invention defines the term consumer to apply to any kind of customer, whether a consumer or a business.

Direct Mail: Any means of promoting one or more products by transmitting to a consumer said promotion through the mail, including, but not limited to: a catalog, a letter, or a physical storage device, e.g., a floppy diskette, compact disc, or digital video disc.

Media Channel: The type of device through which a consumer receives and/or views an advertisement. For example, the present invention defines an advertisement viewed by a consumer on a television set as a television advertisement. An advertisement viewed by a consumer on a personal computer is an Internet advertisement. An advertisement viewed by a consumer on a wireless device is a wireless advertisement, regardless of whether said consumer views an advertisement directly transmitted to said wireless device or an advertisement transmitted as part of a television program transmitted to said wireless device. An advertisement viewed by a consumer in a magazine is a magazine advertisement.

Current media technologies are evolving that could change the type of device through which a consumer views an advertisement transmitted through conventional channels. For example, certain operators are deploying technologies enabling them to transmit television signals by utilizing the Internet Protocol (IP). While they plan to transmit television signals to a television set, transmitting said signals via IP can enable them to transmit said signals to personal computers. The present invention still defines an advertisement viewed by a consumer on a television set as a television advertisement, regardless of whether said consumer views an advertisement transmitted through conventional means or IP.

Operator: The specific operator of a property within any given media channel at which a consumer can view an advertisement. For example, the present invention defines a Direct Mail Operator as an operator of a means of promoting products through the mail in which a consumer can view an advertisement; an Internet Operator as an operator of a web site at which a consumer can view an advertisement, an operator of a search engine at which a consumer can view an advertisement, or an operator of a service enabling email, instant messaging, or any other kind of electronic communication in which a consumer can view an advertisement; an Outdoor Operator as an operator of outdoor platforms or any platform outside of the home at which a consumer can view an advertisement; a Newspaper/Magazine Operator as an operator of a newspaper/magazine at which a consumer can view an advertisement; a Radio Operator as an operator of a radio station (delivered through any wired and/or wireless means, including, but not limited to, cable, terrestrial wireless, satellite, and/or any other communications means) on which a consumer can hear an advertisement; a Television Operator as an operator of a television station or network (delivered through any wired and/or wireless means, including, but not limited to, cable, terrestrial wireless, satellite, and/or any other communications means) on which a consumer can view an advertisement; and a Wireless Operator as an operator of a wireless communications network on which a consumer can view an advertisement.

Product: Any good or service. The good can be a digital or physical good.

Product Category: Any group or class of products that a reasonable consumer would consider as approximately equivalent. The present invention utilizes this definition to enable a comparison of the effectiveness of any given Media Channel, Operator, Program/Page, and/or Space to increase total sales in said category. For example, an Advertiser of automobiles priced below $20,000 wishes to evaluate the effectiveness of two different Programs by learning how viewers of each Program respond to an advertisement of automobiles below $20,000, not an advertisement of all automobiles regardless of price. The present invention can enable the utilization of any definition of Product Category accepted by an Advertiser, including, but not limited to: category as defined by a government agency, e.g., the Standard Industrial Classification; category as defined by an industry group; category as defined by a research group; or category as defined by one or more Advertisers utilizing the present invention. In the last example, an Advertiser can elect to sort any list of available Advertisement Inventory by SOI (defined below) utilizing categories relevant to its product, e.g., automobiles priced below $20,000, automobiles between $20,000 and $40,000, and automobiles above $40,000.

Program/Page: The specific type of content provided by or property operated by a given Operator in which a consumer can view an advertisement. The present invention defines a Page as a specific type of content provided or distributed by an Operator, e.g., a web page including information about diabetes published by an Internet Operator providing health content, a web page including information associated with a given keyword generated by an Internet search engine, an email delivered by an Internet Operator, or a page in a newspaper or magazine about diabetes published by a Newspaper or Magazine Operator, respectively. The present invention defines a Program as a specific type of content provided or distributed by an Operator. For example, an Internet, Television, or Radio Program is a specific type of content provided by an Internet Operator, Television Operator, or Radio Operator, respectively, e.g., a Television Program on baseball provided by a television sports network.

Space: The specific part of a Program/Page in which a consumer can view an advertisement. A Space can have a variety of dimensions, including, but not limited to: space (e.g., the x, y, and/or z spatial coordinates of an advertisement placement), time (e.g., the period of time during which an advertisement is viewed), or embedding (e.g., the usage of a product within a Program/Page or what is commonly referred to as product placement). The present invention defines a Page Space as that part of a Web Page or a Page in a newspaper or magazine in which a consumer can view an advertisement, e.g., the most prominent part of a web page including information about diabetes in contrast to a part of a web page in which a consumer must scroll down to view. A Television Program Space can be that part of a Television Program in which a consumer can view an advertisement, e.g., the central part of the screen in contrast to a peripheral part of the screen if a Television Program can show advertisements in separate parts of the screen simultaneously. The present invention defines a Space to include different times that may be valued by Advertisers differently. For example, a Television Program Space can be one time segment occurring immediately before a Program starts and another time segment occurring immediately after a Program ends. The present invention defines a Space to include the smallest unit of Advertisement Inventory that an Advertiser can purchase on a Program/Page or from an Operator.

Optimum Advertising Budget and Allocation

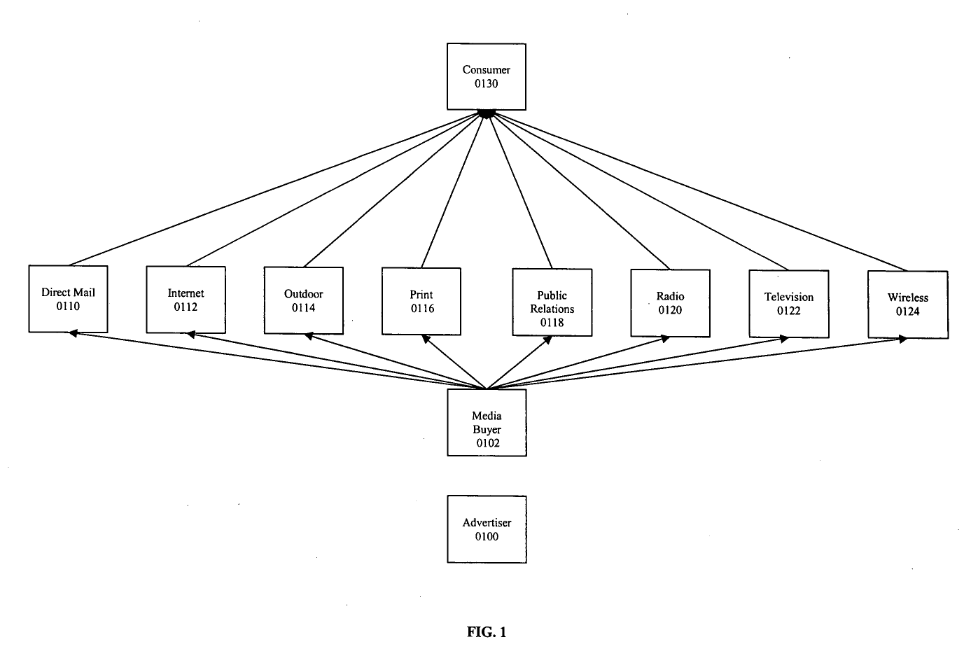

FIG. 1 illustrates a diagram of how a typical media planning or media buying firm views the relationships among an Advertiser, the different Media Channels and Operators, and the consumer. The typical media planner/buyer views a consumer only in terms of the media viewed by said consumer. The typical media planner/buyer does not consider if, how, and when a consumer responds to an advertisement by purchasing the product promoted in said advertisement.

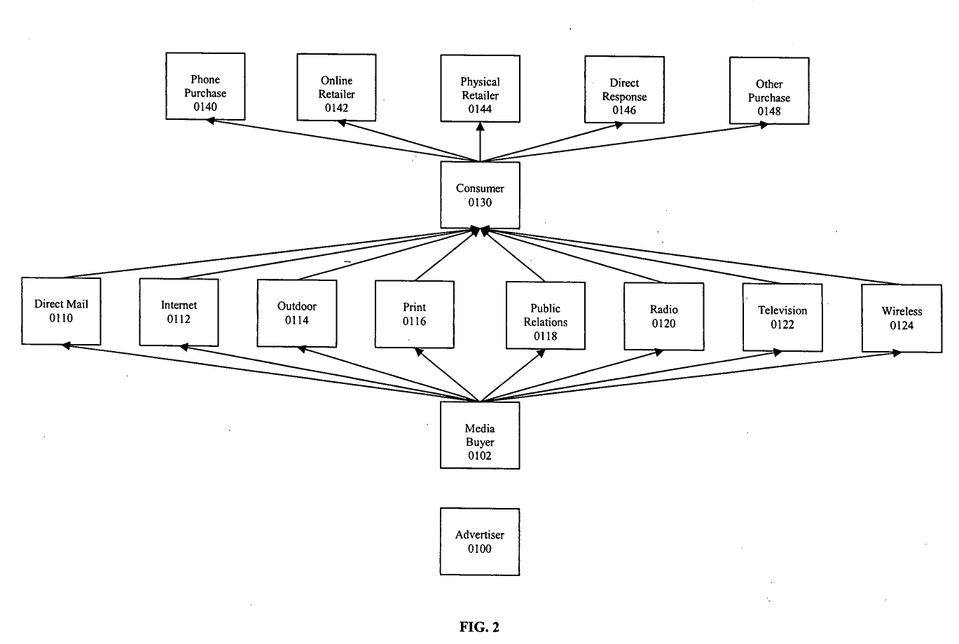

FIG. 2 illustrates a diagram of how a media planner/buyer should view a consumer. It is relevant to consider not only the media viewed by a consumer, but also the purchases made by a consumer after viewing said advertisement among. the different sales channels. How an Advertiser should allocate its advertising budget among the different Media Channels, Operators, Programs/Pages, and/or Spaces should depend, not just on maximizing the number of consumers viewing an advertisement, but on, inter alia, the effectiveness that purchasing any given Advertisement Inventory would have on increasing or maximizing the total sales and/or total profits of an Advertiser.

The present invention can implement the system, apparatus, and methods described in the present application through any single component or combination of software and/or hardware components. The software can execute on any type of hardware located at or distributed among any party, including, but not limited to: an Advertiser, an Operator, or a third party.

The present invention can include a system or apparatus of software enabling any of the methods described in the present application implemented in a single computer, a collection of computers, or other hardware. The present invention can include any of the methods described in the present application implemented in software.

In the preferred embodiment, the steps in any of the present methods are embodied in machine-executable instructions. The present invention can process said instructions in a variety of ways, including, but not limited to: utilizing a general- or special-purpose processor programmed with said instructions to perform the steps in any of the present methods, equivalent or related steps, other or additional steps, or any subset thereof; utilizing certain hardware components that contain hardwired logic to perform the steps in any of the present methods, equivalent or related steps, other or additional steps, or any subset thereof; or utilizing any combination of programmed processors and hardware components to perform the steps in any of the present methods, equivalent or related steps, other or additional steps, or any subset thereof.

The present invention can be a computer program product which can include a computer- or machine-readable media storing thereon said instructions which can program a computer or other hardware to perform the present method or process. The computer- or machine-readable media can include, but is not limited to: floppy disks, magnetic disks, optical disks, magneto-optical disks, CD-ROMs, read-only memory (ROM), random access memory (RAM), programmable read-only memory (PROM), erasable programmable read-only memory (EPROM), electrically erasable programmable read-only memory (EEPROM), magnetic or optical cards, or any other type of media or computer- or machine-readable media capable of storing instructions (“Computer/Machine Readable Media”).

The present invention can be distributed and/or downloaded as a computer program product. The present invention can distribute the program from a remote computer, e.g., a server, to another computer, e.g., a client, through any wired and/or wireless channel over a network, e.g., the Internet.

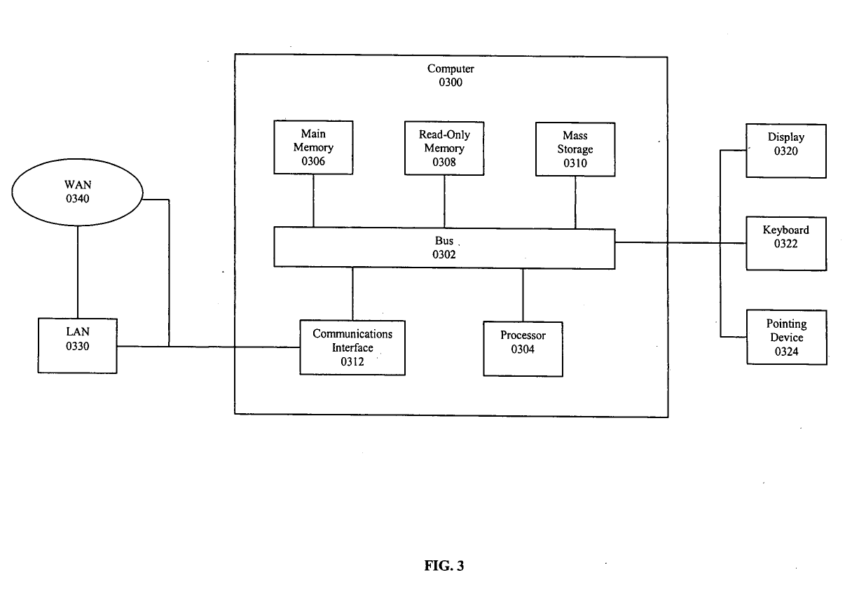

FIG. 3 illustrates an exemplary computer system which can process the present invention. Computer system 0300 can comprise a variety of components, including, but not limited to: a bus 0302 or any other means of transmitting and/or receiving data among components; a general- or special-purpose processor or any other means of processing data 0304; a main memory device 0306 coupled to bus 0302 capable of storing data and instructions executed by processor 0304 or temporary variables or other intermediate data during the execution of instructions by processor 0304; a read-only memory device 0308 coupled to bus 0302 capable of storing static data and instructions executed by processor 0304; a mass storage device 0310 (which can be a non-removable device, e.g., a hard disk drive, or a removable device, e.g., a floppy disk drive, a compact disc drive, a tape drive, or a magneto-optical disc drive) coupled to bus 0302 or computer system 0300 capable of storing data and instructions executed by processor 0304; a display device 0320 coupled to bus 0302 or computer system 0300 capable of displaying data to a computer user; a keyboard device 0322 coupled to bus 0302 or computer system 0300 capable of communicating data and/or enabling command selection to processor 0304; a pointing device 0324 coupled to bus 0302 or computer system 0300 capable of communicating direction information and/or enabling command selection to processor 0304; and/or a communications interface 0312 coupled to bus 0302 or computer system 0300 capable of accessing other computers through a local area network (LAN) 0330 or a wide area network (WAN) 0332, e.g., the Internet. Communications interface 0312 can include a modem, a network interface card, or any other device capable of coupling computer system 0300 to any LAN 0330 or WAN 0332. LAN 0330 and/or WAN 0332 can enable communication through a wired, wireless, or combination of wired and wireless signals.

Computer system 0300 can be any server, workstation, personal computer, portable computer, personal digital assistant, wireless device, or any other device capable of processing the present invention. Any of these devices can communicate with each other utilizing any protocol over any network, including, but not limited to: HyperText Transport Protocol (HTTP) or File Transport Protocol (FTP) over the Internet.

Computer system 0300 can implement any or all of the steps of the present methods through either programmable logic, hard-wired logic, or any combination of programmable and hard-wired logic. In one embodiment, computer system 0300 can have processor 0304 or multiple processors 0304 execute one or more instructions stored in main memory 0306. Main memory 0306 can retrieve said instructions from any other Computer/Machine Readable Media, e.g., mass storage 0310. In another embodiment, computer system 0300 can have processor 0304 or multiple processors 0304 execute one or more instructions that are predefined or hard-wired. In another embodiment, computer system 0300 can have processor 0304 or multiple processors 0304 execute one or more instructions utilizing a combination of programmable and hard-wired logic.

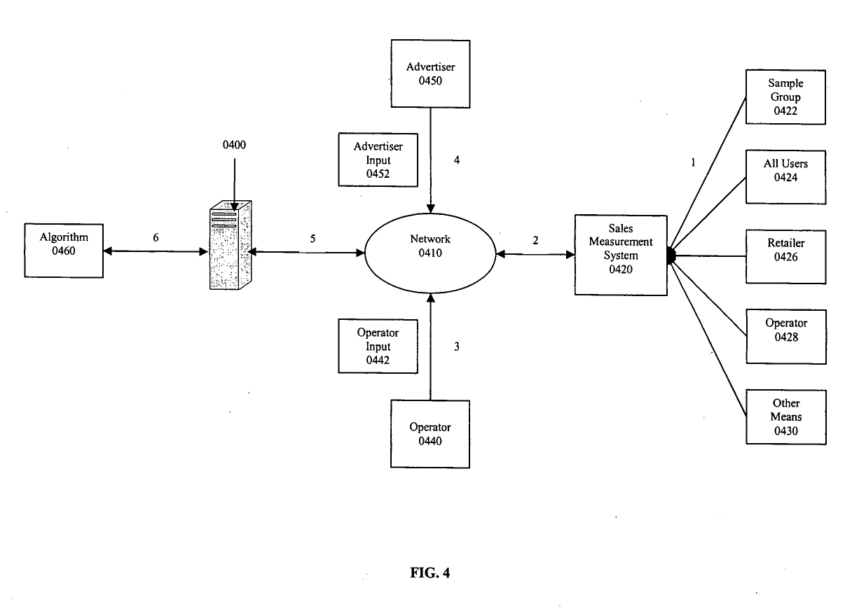

FIG. 4 illustrates an exemplary system of Advertisers, Operators, and third parties operating to enable optimum allocation of an advertising budget. Sales Measurement System 0420 can collect data on the sales or other measure of advertisement effectiveness occurring after the viewing of an advertisement for each Media Channel, Operators, Program/Page, and/or Space from a variety of sources, including, but not limited to: a sample group of consumers 0422 that reflect the same buying characteristics of a larger group of consumers targeted by an Advertiser, any or all consumers 0424 for which said data is available, any or all retailers 0426 that have said data, any or all Operators 0428 that have said data, any other means 0430 of collecting said data, or any combination of sources that can collectively generate data measuring sales or other means of advertisement effectiveness occurring after the viewing of an advertisement. Sales Measurement System 0420 can communicate with Computer 0400 to provide said data for input into the present invention.

Sales Measurement System 0420, Operator 0440, Advertiser 0450, or any third party can communicate with Computer 0400 through a network 0410, which can include, but is not limited to: a LAN or WAN, e.g., the Internet.

Operator 0440 can communicate with Computer 0400 through network 0410 to provide said computer with data on the unit cost and/or total cost of purchasing an advertisement for each Program/Page and/or Space it operates, or any other data required by the present invention (“Operator Input” 0442).

Advertiser 0450 can communicate with Computer 0400 through network 0410 to provide said computer with the data required by the present invention to enable optimum allocation of an advertising budget, including, but not limited to, the data described in Steps A8-A15 (“Advertiser Input” 0452).

Computer 0400 can utilize the Operator Input 0442, Advertiser Input 0452, and data provided by Sales Measurement System 0420, and apply Algorithm 0460 to determine the optimum size of an advertising budget and/or optimize the allocation of an advertising budget among media channels to maximize the sales and/or profits of Advertiser 0450.

In one embodiment of the present system, the present invention can implement any combination or subset of the following, equivalent, or related steps.

A1. Measure the sales occurring after the viewing over some time period of an advertisement for each Media Channel, Operator, Program/Page, and/or Space. For example, measure the sales in a given Product Category after the viewing over some time period of an advertisement in said Product Category for each Media Channel, Operator, Program/Page, and/or Space. To measure said sales, the present invention can utilize the system, methods, and apparatus disclosed in U.S. Patent Applications 60/707,684 and 60/716,089 or any alternative system, methods, and apparatus. These systems, methods, and apparatus can measure said sales by generating, collecting, recording, and/or analyzing data on the purchases made by a consumer and the advertisements viewed by a consumer at a variety of locations, including, but not limited to: any single device or combination of devices operated by the consumer, a retailer, and/or an Operator.

The present invention can measure sales in a variety of ways, including, but not limited to: the unit number of sales or the value of sales occurring after the viewing of said advertisement over some time period; the increase in the unit number of sales or value of sales occurring after the viewing over some time period of said advertisement over some baseline or average unit number of sales or value of sales; or any other way of measuring sales resulting from the viewing of said advertisement over some time period.

The present invention can utilize any measure of sales, including, but not limited to: a historical measure of sales in a given Product Category occurring after the viewing over some time period of an advertisement for each Media Channel, Operator, Program/Page, and/or Space, i.e., the measure of sales of a product occurring after the viewing over some time period of advertisements of said product before an Advertiser decides how to allocate its budget for a current advertisement; a measure of sales in a given Product Category occurring after the viewing over some time period of an advertisement for each Media Channel, Operator, Program/Page, and/or Space among a sample group of consumers that reflects the same buying characteristics of a larger group of consumers targeted by an Advertiser; a measure of sales in a given Product Category occurring after the viewing over some time period of an advertisement for each Media Channel, Operator, Program/Page, and/or Space among any or all consumers from which said measure can be collected; and/or any other measure of sales in a given Product Category occurring after the viewing over some time period of an advertisement for each Media Channel, Operator, Program/Page, and/or Space.

The present invention can measure sales along different dimensions, including, but not limited to: the unit number of total sales or the value of total sales occurring after the viewing of said advertisement over some time period; or the unit number of sales or the value of sales occurring after the viewing over some time period of said advertisement among subgroups of consumers, including, but not limited to: consumers that purchase different variations of the product, e.g., blond, brunette, or red variations of a hair color product; consumers depending on their geographical distribution, e.g., their distance from the location of distribution facilities of an Advertiser; consumers depending on the type of sales channel through which they purchase the product; consumers depending on the probability of utilizing customer service or actual usage of customer service; or consumers depending on their creditworthiness or probability of utilizing coupons.

The present invention can collect for each Media Channel, Operator, Program/Page, and/or Space data on the sales through a variety of ways, including, but not limited to: data provided by each Operator, data provided by a retailer, data collected by an Operator, a retailer, or a third party from a sample of consumers representative of the consumers to which Advertisers want to promote their products, and/or historical or current data collected from each consumer which can provide Advertisers information on his/her willingness to buy their products. The present invention can collect data on the sales occurring in any sales channel, including, but not limited to: purchases from an online retailer, purchases from a physical retailer, purchases through a phone, or purchases through the mail (e.g., order from a mail-order catalog or response to a direct mail letter).

A2. Calculate for each Media Channel, Operator, Program/Page, and/or Space the ratio of: (a) the sales in a given Product Category occurring after the viewing of an advertisement over some time period; to (b) the number or cost of said advertisements viewed over some time period (“Sales on Investment” or SOI). The present invention can calculate said ratio or SOI in a variety of ways, including, but not limited to: the unit number of sales occurring after the viewing over some time period of an advertisement to the number or cost of advertisements viewed; the value of sales occurring after the viewing over some time period of an advertisement to the number or cost of advertisements viewed; the difference between the unit number of sales occurring after the viewing over some time period of an advertisement and some historical average number of sales to the number or cost of advertisements viewed; the difference between the value of sales occurring after the viewing over some time period of an advertisement and some historical average value of sales to the number or cost of advertisements viewed; or any other way of measuring the SOI of an advertisement. To calculate the cost of advertisements, the present step can utilize data from Step A7.

For example, a sample group of consumers that reflects the same buying characteristics of a larger group of consumers targeted by an Advertiser can generate a ratio of three (3) unit sales in a Product Category of automobiles of sports utility vehicle (SUV) type priced between $20,000 and $40,000 over a one-week period out of one-thousand viewings of an advertisement in said Product Category during given Television Program₁. The same sample group of consumers can generate a ratio of seven (7) unit sales in the same Product Category over the same time period out of one-thousand viewings of an advertisement in said Product Category when viewing the results of a given keyword search on an Internet Search Engine₁. In the present example, the SOI for Television Program₁ is 0.3% and the SOI for Internet Search Engine₁ is 0.7%.

The present invention can calculate the SOI of any given Media Channel, Operator, Program/Page, and/or Space along any dimension, including, but not limited to: measuring the sales and/or advertisements for all Products for the Media Channel, Operator, Program/Page, and/or Space to generate the SOI; measuring the sales and/or advertisements in a given Product Category for the Media Channel, Operator, Program/Page, and/or Space to generate the SOI; measuring the sales and/or advertisements in a given demographic group of users for the Media Channel, Operator, Program/Page, and/or Space to generate the SOI; and/or measuring the sales and/or advertisements for any group of users classified by any criterion other than demographics for the Media Channel, Operator, Program/Page, and/or Space to generate the SOI.

For example, the present invention can calculate the SOI of an Internet search engine along several dimensions. First, it can calculate the SOI for all Products purchased by users of an Internet search engine after viewing all advertisements viewed by the users. Second, it can calculate the SOI for a Product Category of interest to an Advertiser, e.g., the number of automobiles, in general, or SUVs, in particular, purchased by users of an Internet search engine after viewing all automobile advertisements, in general, or SUV advertisements, in particular at the Internet search engine. Third, it can calculate the SOI for a given demographic group of users of interest to an Advertiser, e.g., the number of Products purchased by users aged 18-34 years old of an Internet search engine after viewing all advertisements for the Products at the Internet search engine. Fourth, it can calculate the SOI for a group of users who purchase Products after using the Internet search engine on a Personal Computer after viewing all advertisements for the Products at the Internet search engine and compare the SOI for a group of users who purchase Products after using the Internet search engine on a Wireless Device after viewing all advertisements for the Products at the Internet search engine.

To measure the advertisements viewed and/or the sales occurring after viewing the advertisements, the present invention can utilize the system, methods, and apparatus disclosed in U.S. Patent Applications 60/707,684 and 60/716,089 or any alternative system, methods, and apparatus. These systems, methods, and apparatus can measure said advertisements viewed by generating, collecting, recording, and/or analyzing data on the advertisements viewed by a consumer at a variety of locations, including, but not limited to: any single device or combination of devices operated by the consumer, a retailer, an Operator, and/or a third party.

A3. Measure any intermediate results, i.e., any outcome desired by an Advertiser short of a sale occurring after the viewing over some time period of an advertisement (“Intermediate Result”) for each Media Channel, Operator, Program/Page, and/or Space. For example, measure the Intermediate Results in a given Product Category after the viewing over some time period of an advertisement in said Product Category for each Media Channel, Operator, Program/Page, and/or Space. These Intermediate Results can include, but are not limited to: sampling the product; visiting a physical or online retailer selling said product; selecting an advertisement using any method, including, but not limited to: clicking an hypertext link on a web page, and/or mailing a card to request product information; calling a phone number provided on an advertisement; searching for information on said product; and/or viewing said advertisement more than once in cases where a media device can store said advertisement. To measure said Intermediate Results, the present invention can utilize the system, methods, and apparatus disclosed in U.S. Patent Applications 60/707,684 and 60/716,089 or any alternative system, methods, and apparatus. These systems, methods, and apparatus can measure said Intermediate Results by generating, collecting, recording, and/or analyzing data on the Intermediate Results generated by a consumer and the advertisements viewed over some time period by a consumer at a variety of locations, including, but not limited to: any combination of devices operated by the consumer, a retailer, and/or an Operator.

The present invention can measure Intermediate Results in a variety of ways, including, but not limited to: the number of Intermediate Results or the value of Intermediate Results occurring after the viewing of said advertisement over some time period; the increase in the number of Intermediate Results or value of Intermediate Results occurring after the viewing over some time period of said advertisement over some baseline or average number of Intermediate Results or value of Intermediate Results; or any other way of measuring Intermediate Results resulting for the viewing of said advertisement over some time period.

The present invention can utilize any measure of Intermediate Results, including, but not limited to: a historical measure of Intermediate Results occurring after the viewing over some time period of an advertisement for each Media Channel, Operator, Program/Page, and/or Space, i.e., the measure of Intermediate Results of a product occurring after the viewing over some time period of advertisements of said product before an Advertiser decides how to allocate its budget for a current advertisement; a measure of Intermediate Results occurring after the viewing over some time period of an advertisement for each Media Channel, Operator, Program/Page, and/or Space among a sample group of consumers that reflect the same buying characteristics of a larger group of consumers targeted by an Advertiser; or any other measure of Intermediate Results occurring after the viewing over some time period of an advertisement for each Media Channel, Operator, Program/Page, and/or Space.

The present invention can collect for each Media Channel, Operator, Program/Page, and/or Space data on the Intermediate Results through a variety of ways, including, but not limited to: data provided by each Operator, data provided by a retailer, data collected by an Operator, a retailer, or a third party from a sample of consumers representative of the consumers to which Advertisers want to promote their products, and/or historical or current data collected from each consumer which can provide Advertisers information on his/her willingness to generate Intermediate Results regarding their products. The present invention can collect data on the sales occurring in any sales channel, including, but not limited to: Intermediate Results related to an online retailer, Intermediate Results related to a physical retailer, Intermediate Results generated through a phone, or Intermediate Results generated through the mail (e.g., order from a mail-order catalog or response to a direct mail letter).

A4. Calculate for each Media Channel, Operator, Program/Page, and/or Space the ratio of: (a) the Intermediate Results in a given Product Category occurring after the viewing of an advertisement over some time period; to (b) the number or cost of advertisements viewed over some time period (“Intermediate Results on Investment” or IROI). The present invention can calculate said ratio or IROI in a variety of ways, including, but not limited to: the number of Intermediate Results occurring after the viewing over some time period of an advertisement to the number or cost of advertisements viewed; the value of Intermediate Results (as defined or measured by an Advertiser) occurring after the viewing over some time period of an advertisement to the number or cost of advertisements viewed; the difference between the number of Intermediate Results occurring after the viewing over some time period of an advertisement and some historical average number of Intermediate Results to the number or cost of advertisements viewed; the difference between the value of Intermediate Results occurring after the viewing over some time period of an advertisement and some historical average value of Intermediate Results to the number or cost of advertisements viewed; or any other way of measuring the benefits to an Advertiser short of a sale resulting from a purchase of an advertisement. To calculate the cost of advertisements, the present step can utilize data from Step A7.

To measure the advertisements viewed, the present invention can utilize the system, methods, and apparatus disclosed in U.S. Patent Applications 60/707,684 and 60/716,089 or any alternative system, methods, and apparatus. These systems, methods, and apparatus can measure said advertisements viewed by generating, collecting, recording, and/or analyzing data on the advertisements viewed by a consumer at a variety of locations, including, but not limited to: any single device or combination of devices operated by the consumer, a retailer, an Operator, and/or a third party.

A5. Store for each Media Channel, Operator, Program/Page, and/or Space the data collected in Step A1 and/or Step A3, and/or the measures of SOI and/or IROI at any location, including, but not limited to: the wireless device utilized by a consumer that generates and collects the data in Step A1 and/or Step A3, a wired device utilized by a consumer that generates and collects the data in Step A1 and/or Step A3; a server located on the wired and/or wireless network to which the wireless and/or wired device utilized by a consumer connects; a server operated by a retailer; a server operated by an Advertiser; and/or a server operated by a third party.

A6. Rank the measures of SOI and/or IROI across each Media Channel, Operator, Program/Page, and/or Space. For example, assume there are four television Operators, each of which broadcasts four programs, and each of the programs has two spaces. Step A6 can rank the SOI and/or IROI of each of the four television Operators from highest to lowest. Step A6 can rank the SOI and/or IROI of each of the 16 programs offered by the four Operators from highest to lowest. Step A6 can rank the SOI and/or IROI of each of the 32 Spaces offered by the four Operators from highest to lowest.

A7. Collect for each Media Channel, Operator, Program/Page, and/or Space the unit cost and/or total cost of purchasing any given advertisement. The cost can be a unit cost, i.e., the cost of purchasing any unit of advertisement, e.g., a banner on a web page, a keyword or an ad associated with keywords on a search engine, an ad on a billboard, an ad in a newspaper or magazine, an ad of any time period during a radio program, an ad of any time period during a television program, or a product placement during a television program. The cost can be the total cost, e.g., the cost of purchasing a collection of units of advertisements. An Operator can provide a quote of the cost of purchasing a collection of advertisements. Said collection can include, but is not limited to: advertisements on a collection of Programs, Pages, and/or Spaces, e.g., ten 30-second spots on several television Programs provided by a Television Operator; advertisements across a collection of Programs or Pages, e.g., three 30-second spots on television programs, three 60-second spots on radio programs, and four banners on Pages, all of which are provided by a single Operator; or advertisements on any combination of Programs or Pages.

For example, the present invention can collect from a given Internet Operator, Television Operator, or Radio Operator the cost of purchasing an advertisement. An Operator can offer quotes in a variety of ways, including, but not limited to: (a) offering a quote that is fixed in price or a quote that varies in price depending on the real-time demand for and supply of its Advertisement Inventory; (b) offering a quote that varies in price depending on the volume of Advertisement Inventory purchased; (c) offering a quote for short-term Advertisement Inventory comparable to the spot market in television Advertisement Inventory or a quote for long-term Advertisement Inventory comparable to the upfront television advertisement market or long-term contracts; and/or (d) offering a quote for Space(s) within a single Media Channel, e.g., a collection of Advertisement Inventory within the Internet, or across different Media Channels, e.g., offering a collection of Advertisement Inventory across Internet, television, radio, magazines, and outdoor.

A8. Collect from an Advertiser the unit cost and/or total cost of manufacturing the product for any given level of sales of the product advertised, given distribution of sales by the type of product purchased by the customer, given timing of sales of said product, or any other variable that can affect the unit or total cost of manufacturing the product. The unit cost of manufacturing a product typically decreases with increasing volume. The unit cost of manufacturing a product typically can depend on the degree to which a vendor tailors the production for a given type of customer preferring different variations of the product (e.g., one hair coloring product can have different colors for blonde, brunette, and red). The present invention can incorporate the manufacturing cost data to help determine the optimum allocation of an advertising budget which can maximize profits, which depend in part on the manufacturing cost. The present invention can include purchasing costs when estimating the unit cost and/or total cost of manufacturing a product.

A9. Collect from an Advertiser the unit cost and/or total cost of distributing the product for any given level of sales of the product advertised, given geographical distribution of sales of said product, given timing of sales of said product, or any other variable that can affect the unit or total cost of distributing the product. The unit cost of distributing a product typically depends on the distance between the customer or retailer and the distribution center of the vendor. Such differences in distribution costs could affect the profitability of advertising in one geographical area over another. The present invention can incorporate the distribution cost data to help determine the optimum allocation of an advertising budget which can maximize profits, which depend in part on the distribution cost.

A10. Collect from an Advertiser the amount of inventory of the product available at the retailer, distributor, the manufacturer, and/or any third party. The amount of inventory can affect the ability of an Advertiser to capitalize on the increased demand from consumers viewing an advertisement. Holding a level of inventory lower than the demand resulting from an advertisement could cause stockouts and lost sales opportunities. Holding a level of inventory higher than the demand resulting from an advertisement could cause excess inventories and write-downs. The present invention can incorporate the inventory data to help determine the optimum allocation of an advertising budget which can maximize profits, which depend in part on the amount of inventories and minimizing the expense of holding excess inventories, which can include, but is not limited to: interest expense and carrying cost.

A11. Collect from an Advertiser the unit price of selling the product. The unit price charged or suggested by an Advertiser can affect the unit volume of sales of said product, which in turn can affect the costs of manufacturing, distributing, selling, servicing, and financing the product. Such differences in unit prices could affect the profitability of advertising at one price or another. The present invention can incorporate the unit price data to help determine the optimum allocation of an advertising budget which can maximize profits, which depend in part on the unit price.

A12. Collect from an Advertiser the unit cost and/or total cost of marketing the product (where Step A12 can exclude advertising expenses) for any given level of sales of the product advertised, given timing of sales of said product, given type of sales channel of said product, or any other variable that can affect the unit or total cost of marketing the product.

A13. Collect from an Advertiser the unit cost and/or total cost of selling the product for any given level of sales of the product advertised, given geographical distribution of sales of said product, given timing of sales of said product, given type of sales channel of said product, or any other variable that can affect the unit or total cost of selling the product. The unit cost of selling a product typically depends on the type of sales channel. A vendor could sell its product through a variety of ways, including, but not limited to: its online retail channel, its phone retail channel, its direct mail retail channel, and/or its own physical retail channel. The cost of selling its product through its online retail channel could include the cost of any online sales personnel and online technology, the cost of selling its product through its phone retail channel could include the cost of customer service personnel, the cost of selling its product through its direct mail retail channel could include the cost of producing and mailing catalogs, and the cost of selling its product through its own physical retail channel would include the cost of the sales personnel, real estate, and store operations. Such differences in selling costs could affect the profitability of advertising that encourages consumers to use one sales channel over another. The present invention can incorporate the sales cost data to help determine the optimum allocation of an advertising budget which can maximize profits, which depend in part on the selling cost.

A14. Collect from an Advertiser the unit cost and/or total cost of providing customer service for any given level of sales of the product advertised, given geographical distribution of sales of said product, given timing of sales of said product, given type of customer of said product, or any other variable that can affect the unit or total cost of providing customer service for the sale. The unit customer service cost of a product can depend on the type of customer of said product. For example, a customer who is buying a personal computer for the first time can require more assistance from customer service than a customer who has bought personal computers before. Such differences in customer service costs could affect the profitability of advertising to one customer group over another. The present invention can incorporate the customer service cost data to help determine the optimum allocation of an advertising budget which can maximize profits, which depend in part on the customer service cost.

A15. Collect from an Advertiser the unit cost and/or total cost of financing the sale of a product for any given level of sales of the product advertised, given geographical distribution of sales of said product, given timing of sales of said product, given type of customer of said product, or any other variable that can affect the unit or total cost of financing the sale of the product. The unit financing cost of a product can depend on a variety of factors, including, but not limited to: the creditworthiness of a customer and the probability that a given customer will redeem coupons. Such differences in financing costs could affect the profitability of advertising to one customer group over another. The present invention can incorporate the financing cost data to help determine the optimum allocation of an advertising budget which can maximize profits, which depend in part on the financing cost.

A16. Calculate for each Media Channel, Operator, Program/Page, and/or Space the profit margin of purchasing a unit of Advertisement Inventory for a given Product Category promoted by said advertisement. The present invention defines the unit sales of product for a given Product Category occurring after viewing of advertisement for said given Product Category over some time period as “Unit Product Sales”. For example, if an Advertiser in the Product Category of SUVs priced between $20,000 and $30,000 wants to purchase an advertisement, Unit Product Sales could equal unit sales of SUVs priced between $20,000 and $30,000 occurring after viewing advertisements for said Product Category over some time period. In one embodiment, an Advertiser can calculate the Profit Margin as follows:

Let SOI for any given Advertisement Inventory a

SOIₐ=(Unit Product Sales)/(Number of Advertisements Viewed)

Let Unit Revenuesₐ=SOIₐ*(Unit Price of Product)

Let Unit Ad Costsₐ=(Unit Cost of Purchasing Advertisement)

Profit Marginₐ=Unit Revenues−Unit Ad Costs

If there is no data for Unit Product Sales for a given unit of Advertisement Inventory, then the present method could exclude said Advertisement Inventory from Step A17 and/or Step A18. In another embodiment, the present method could include in Step A17 and/or Step A18 said Advertisement Inventory and assign a number or range for Unit Product Sales based on comparable Advertisement Inventory. For example, if there is no data for Unit Product Sales for Advertisement Inventory offered by a web page W₁ or television program T₁, the present method could assign a number for Unit Product Sales or SOI for W₁ or T₁ that is similar to the Unit Product Sales or SOI for a comparable web page or television network.

The present method should calculate the Profit Margin for any given Advertisement Inventory a by utilizing the SOI and Unit Ad Costs for the same Advertisement Inventory. That is, there should be some means of ensuring that the present method associates the SOI of a given Advertisement Inventory a with the Unit Ad Costs of the same Advertisement Inventory a. The present method can ensure such consistency in a variety of ways, including, but not limited to:

Utilizing a tag to identify any given Advertisement Inventory a when both measuring the terms making up SOI and collecting Unit Ad Costs for said inventory and matching tags. When measuring the number of advertisements viewed in Steps A1-A4, the present method can utilize a tag to identify the Media Channel, Operator, Program/Page, and/or Space in which a consumer viewed an advertisement. For example, if a consumer views an advertisement on W₁ or T₁, the present method can assign a tag identifying W₁ as the web page on which said consumer viewed said advertisement or T₁ as the television program during which said consumer viewed said advertisement. The present method can associate the tag with said advertisement in a variety of ways, including, but not limited to: inclusion in a file associated with said advertisement; embedding in said advertisement; and/or comparison of the timing of the advertisement with a database listing the timing of advertisements on any given Media Channel, Operator, Program/Page, and/or Space. A variety of parties can generate the tag. These parties can include, but are not limited to: an Advertiser, an Operator, an industry trade group, and/or a third party. The tag can be any kind of data type, including, but not limited to: a numerical code, an alphanumerical code, text, audio, barcode, image, video, or any combination thereof. An example of the generation, utilization, and matching of said tags is Ad Data Cookies disclosed in U.S. Patent Applications 60/707,684 and 60/716,089.

If an Operator quotes a Unit Ad Cost for a given Advertisement Inventory a identified by a tag, the present method can associate the SOI for said Advertisement Inventory identified by the same tag.

The present method can calculate the Profit Margin of any given Advertisement Inventory a as equal to the difference between Unit Revenues and Unit Ad Costs regardless of the number of available units in the same, contiguous, or nearby Program/Page(s) and/or Space(s).

An advertisement appearing in the same, contiguous, or nearby Program/Page(s) and/or Space(s) could have a different impact on the probability of a consumer purchasing the product promoted or producing an Intermediate Result. For example, a repeat display of the same advertisement in one television Program can increase the probability of a consumer purchasing the product promoted, because repetition could make the consumer notice the advertisement or remember it more clearly. On the other hand, a repeat display of the same advertisement in one television Program can decrease the probability of a consumer purchasing the product promoted, because repetition could annoy the consumer. Alternatively, a repeat display of the same advertisement in one television Program can still generate a positive but lower Profit Margin than that of the initial display of the same advertisement, because of diminishing marginal returns.

Because of the above different impacts, the present method in another embodiment can adjust the SOI for any given Advertisement Inventory a to reflect the different impacts from repeat displays in the same, contiguous, or nearby Program/Page(s) and/or Space(s) (“Adjusted SOI”). The present method can adjust the SOI in a variety of ways, including, but not limited to:

Utilize data generated and/or collected in Step A1 that measures how the SOI of a repeat display of the same advertisement displayed in the same, contiguous, or nearby Program/Page(s) and/or Space(s) varies, e.g., Step A1 can collect data from a sample group of users that show for a given advertisement in a given Product Category in a given Program, the SOI of the first display in said Program of an advertisement is x percent higher or lower than the SOI of a second display in said Program within t seconds of the same advertisement; and/or

Allow an Advertiser, Operator, or third party to adjust the SOI depending on how said party believes the SOI would vary with a repeat display of the same advertisement displayed in the same, contiguous, or nearby Program/Page(s) and/or Space(s), e.g., if an Advertiser believes that a repeat display of the same advertisement in a web page that is directly linked to another web page managed by the same Operator would decrease the probability of a consumer purchasing the product promoted, the present method can allow for said Advertiser to reduce the SOI for said Page by whatever amount it considers appropriate.

In another embodiment, the present method can define the SOI as the ratio of the Unit Intermediate Results to the number of advertisements viewed, where Unit Intermediate Results equal the number of Intermediate Results for a given Product Category occurring after viewing of an advertisement for said Product Category over some time period.

A17. To maximize total profit of an Advertiser without considering any costs other than the cost to purchase Advertisement Inventory, the present invention in one embodiment can apply the following algorithm:
a. Select each unit of Advertisement Inventory available for the Product Category and during the time period specified by the Advertiser.
b. Sort the list of available units of Advertisement Inventory by Profit Margin (calculated in Step A16 utilizing either SOI or Adjusted SOI for the Product Category specified by the Advertiser) in descending order from highest Profit Margin.
c. Define the Constraint (Budget (Ad))=the total amount of money an Advertiser wishes to spend on an advertisement.
d. Select the highest ranking available units of Advertisement Inventory until inventory of said advertisement units equals zero.
e. When the inventory of highest ranking available units of Advertisement Inventory equals zero, select the next highest ranking available units of Advertisement Inventory until said inventory equals zero.
f. Repeat step e.
g. Halt when sum of the Unit Ad Costs equals the Constraint (Budget (Ad)).
h. Purchase those units of Advertisement Inventory selected in Substeps d-f.

To illustrate the present algorithm, consider the following example showing how the present algorithm can maximize total profit of an Advertiser considering only the costs of purchasing Advertisement Inventory.

Assume that an Advertiser wants to spend $5,000,000 on an advertising campaign to launch a new product in Product Category X, a unit price of $5.00, the following Advertisement Inventory is available during a time period of interest to an Advertiser, and the respective SOI for the same Product Category X, Unit Ad Cost of each Space, Profit Margin for each Space, and amount of Inventory available for each Space (as measured in dollars):

| | | Unit | Unit | | |
|---|---|---|---|---|---|
| Advertisement | SOI | Sales | Ad Cost | Profit Margin | Unit Inventory |
| Internet Ad₁ | 0.075 | 0.38 | 0.015 | $0.36 | 2,000,000 |
| Internet Ad₂ | 0.040 | 0.20 | 0.020 | $0.18 | 500,000 |
| Internet Ad₃ | 0.030 | 0.15 | 0.003 | $0.15 | 4,000,000 |
| Television Ad₁ | 0.050 | 0.25 | 0.020 | $0.23 | 1,000,000 |
| Television Ad₂ | 0.025 | 0.10 | 0.015 | $0.09 | 2,000,000 |
| Television Ad₃ | 0.002 | 0.01 | 0.020 | −$0.01 | 2,000,000 |
| Magazine Ad₁ | 0.080 | 0.40 | 0.010 | $0.39 | 500,000 |
| Magazine Ad₂ | 0.025 | 0.13 | 0.008 | $0.12 | 1,000,000 |
| Magazine Ad₃ | 0.020 | 0.10 | 0.004 | $0.10 | 2,000,000 |

To maximize Total Profit considering only costs of purchasing Advertisement Inventory, the present invention can apply the following algorithm:

a. Select each unit of Advertisement Inventory available for Product Category X and during the time period specified by the Advertiser.

b. Sort the list of available units of Advertisement Inventory by Profit Margin for the Product Category specified by the Advertiser (calculated in Step A16) in descending order from highest Profit Margin.

| | | | | | |
|---|---|---|---|---|---|
| Magazine Ad₁ | 0.080 | 0.40 | 0.010 | $0.39 | 500,000 |
| Internet Ad₁ | 0.075 | 0.38 | 0.015 | $0.36 | 2,000,000 |
| Television Ad₁ | 0.050 | 0.25 | 0.020 | $0.23 | 1,000,000 |
| Internet Ad₂ | 0.040 | 0.20 | 0.020 | $0.18 | 500,000 |
| Internet Ad₃ | 0.030 | 0.15 | 0.003 | $0.15 | 4,000,000 |
| Magazine Ad₂ | 0.028 | 0.14 | 0.008 | $0.13 | 1,000,000 |
| Magazine Ad₃ | 0.023 | 0.11 | 0.006 | $0.11 | 2,000,000 |
| Television Ad₂ | 0.025 | 0.13 | 0.030 | $0.10 | 2,000,000 |
| Television Ad₃ | 0.002 | 0.01 | 0.020 | −$0.01 | 2,000,000 |

In this example, the sorted list shows that the most profitable Advertisement Inventory for this Advertiser tends to correlate more closely with the SOI than with Unit Ad Cost. In other examples, the most profitable Advertisement Inventory could correlate more closely with the Unit Ad Cost than with the SOI.

c. Define the Constraint (Budget (Ad))=$5,000,000.

d. Select the highest ranking available units of Advertisement Inventory until inventory of said advertisement units equals zero.

Select $500,000 of Magazine Ad₁

e. When the inventory of highest ranking available units of Advertisement Inventory equals zero, select the next highest ranking available units of Advertisement Inventory until said inventory equals zero. Select $2,000,000 of Internet Ad₁

f. Repeat step e.

Select $1,000,000 of Television Ad₁

Select $500,000 of Internet Ad₂

Select $1,000,000 of Internet Ad₃

g. Halt when sum of the Unit Ad Costs equals the Constraint (Budget (Ad)).
($500,000)+($2,000,000)+($1,000,000)+($500,000)+($1,000,000)=$5,000,000

h. Purchase those units of Advertisement Inventory selected in Substeps d-f.

Purchase $500,000 of Magazine Ad₁

Purchase $2,000,000 of Internet Ad₁

Purchase $1,000,000 of Television Ad₁

Purchase $500,000 of Internet Ad₂

Purchase $1,000,000 of Internet Ad₃

The present algorithm in Step A17 can enable an Advertiser to incorporate the data collected on the Intermediate Results for each Media Channel, Operator, Program/Page, and/or Space by substituting or adding said data to the Profit Margin in Step A17b. Said process can enable an Advertiser to sort the list of available units of Advertisement Inventory not only by the effectiveness of each Media Channel, Operator, Program/Page, and/or Space in generating sales, but also in generating Intermediate Results.

Conventional media planning strategy often spreads an advertising budget among different Media Channels or among different Programs/Pages within any given Media Channel. The present invention teaches a method of allocating an advertising budget based on the present algorithm. If there is sufficient inventory of the Advertisement with the highest ranking Profit Margin (as measured in the present algorithm or through any other method), the present method would allocate the entire advertising budget to that specific Program/Page and/or Space.

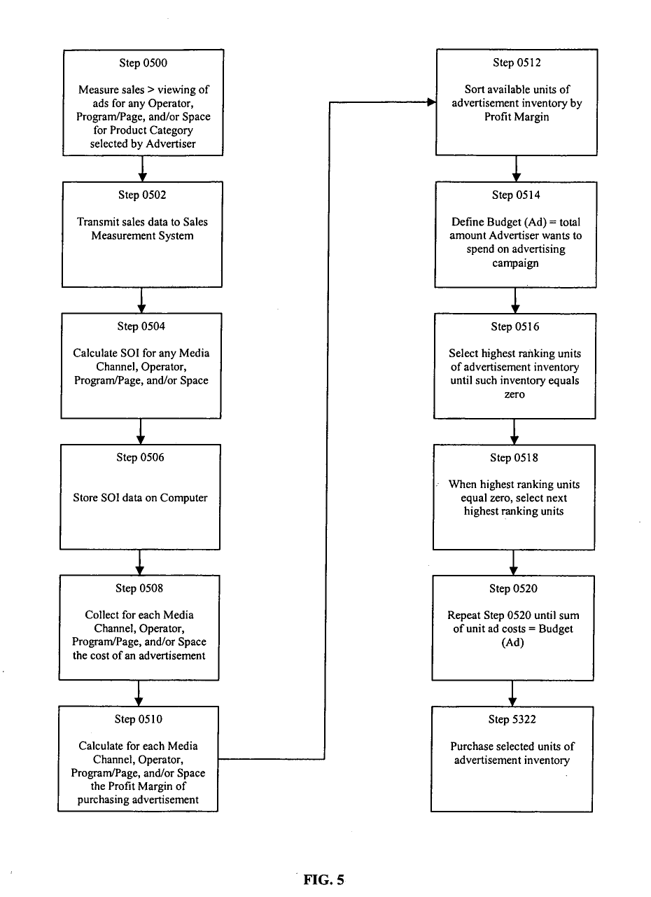

FIG. 5 is a flow chart of one embodiment of the present system optimizing allocation of an advertising budget considering only the cost to purchase Advertisement Inventory. Understanding of FIG. 5 will be apparent to persons skilled in the relevant arts based on the teachings provided herein.

A18. To maximize total profit of an Advertiser while considering most or all of the costs that depend on either the Advertisement Inventory purchased by said Advertiser and/or the total sales that result or the Advertiser expects to result from purchasing said Advertisement Inventory, apply the following process:

In the following calculation, an Advertiser can estimate the total sales of product occurring after viewing of advertisement over some time period (“Total Product Sales”) by utilizing a variety of ways, including, but not limited to: extrapolating the Total Product Sales from the Unit Product Sales observed in a representative sample group, estimating the Total Product Sales from a model relating said sales to the amount and/or type of Advertisement Inventory purchased, or estimating the Total Product Sales from the total product sales resulting from previous comparable advertisements. In one embodiment, an Advertiser can calculate the total profit as a function of amount and/or type of Advertisement Inventory, and/or amount and/or composition of Total Product Sales (“Total Profit”) as follows:

Let SOIₐ=(Unit Product Sales)/(Number of Advertisements Viewed)

Let Unit Revenuesₐ=SOIₐ*(Unit Price of Product)

Let Unit Ad Costsₐ=(Unit Cost of Purchasing Advertisement)

Profit Marginₐ=Unit Revenues−Unit Ad Costs

Let Advertisement Production Costs=Total costs of producing one or more advertisements that are part of the advertising campaign promoting the Product

Let Total Manuf Costs=Total Manufacturing Costs (Total Product Sales, Distribution of Sales by Type of Product Purchased by Customers)

Let Total Distribution Costs=Total Distribution Costs (Total Product Sales, Distribution of Sales by Geography of Customer Purchase)

Let Total Inventory Costs=Total Inventory Costs (Total Product Sales, Distribution of Type of Product Purchased by Customers)

Let Total Marketing Costs=Total (non-advertising) Marketing Costs (Total Product Sales, Distribution of Sales Among Channels Through Which Customers Purchase Product)

Let Total Selling Costs=Total Selling Costs (Total Product Sales, Distribution of Sales by Geography of Customer Purchase, Distribution of Sales Among Channels Through Which Customers Purchase Product)

Let Total Servicing Costs=Total Customer Service Costs (Total Product Sales, Distribution of Sales Among Customers Requiring Different Level of Service)

Let Total Financing Costs=Total Financing Costs (Total Product Sales, Distribution of Sales Among Customers With Different Financing Costs)

Let Total Budget (Ad)=Total amount of money an Advertiser should spend on purchasing Advertisement Inventory that maximizes Total Profit

Step A18 can calculate and utilize Adjusted SOIₐ in lieu of SOIₐ in a similar manner as Steps A16 and A17 to reflect the different impacts from repeat displays in the same, contiguous, or nearby Program/Page(s) and/or Space(s).

There are other costs incurred by an Advertiser (e.g., certain general and administrative expenses, research and development expenses, and taxes) that affect its net income as determined by Generally Accepted Accounting Principles. However, the present invention considers those costs that affect the profit of an Advertiser that depend on the amount and/or type of Advertisement Inventory purchased by an Advertiser and/or the amount and/or composition of total sales resulting or what an Advertiser expects to result from purchasing said Advertisement Inventory.

In one embodiment, an Advertiser would calculate the Total Advertisement Production Costs, Total Manufacturing Costs, Total Distribution Costs, Total Inventory Costs, Total Marketing Costs, Total Selling Costs, Total Servicing Costs, and Total Financing Costs as a function of the variables listed above and listed in Steps A8-A15 (“Cost Functions”). The Advertiser could find the optimum amount and total Advertisement Inventory and selection of each type of Advertisement Inventory to maximize Total Profit by utilizing a variety of ways, including, but not limited to: providing these Cost Functions to a third party that would utilize said Cost Functions and select the optimum amount and/or combination of available Advertisement Inventory to maximize Total Profit subject to the constraints of the Cost Functions, having a third party generate a candidate list of optimum combinations of available Advertisement Inventory and then selecting that amount and/or combination of available Advertisement Inventory to maximize Total Profit subject to the constraints of the Cost Functions, or directly generating a candidate list of optimum combinations of available Advertisement Inventory and then selecting that amount and/or combination of available Advertisement Inventory to maximize Total Profit subject to the constraints of the Cost Functions.

Apply the following algorithm:

Define Total Profit=(Total Product Sales) less Σ
[(Σ Cost of all Advertisement Inventory purchased)
+(Total Advertisement Production Costs)
+(Total Manuf Costs)
+(Total Distribution Costs)
+(Total Inventory Costs)
+(Total Marketing Costs)
+(Total Selling Costs)
+(Total Servicing Costs)
+(Total Financing Costs)]

Find that optimum or close to optimum combination of the values of the following variables (“Profit Maximization Variables”) that can affect the profit of an Advertiser and depend on the amount and/or type of Advertisement Inventory purchased by an Advertiser and/or the amount and/or composition of total sales resulting or what an Advertiser expects to result from purchasing said Advertisement Inventory, which can include, but are not limited to:

Total Budget (Ad), and/or

Distribution of Total Budget (Ad) Spent Among Different Media Channels, Operators, Programs/Pages, and/or Spaces (“Optimal Advertisement Inventory Selected”). (In one embodiment, the present invention can define the variable, Optimal Advertisement Inventory Selected, as the specific units selected by the present algorithm to be purchased by an Advertiser of each Advertisement Inventory among the different Media Channels, Operators, Programs/Pages, and/or Spaces. For example, Optimal Advertisement Inventory Selected can include the units of Advertisement Inventory selected in the example of Step A17.h.)

such that a combination of values maximizes Total Profit.

To maximize Total Profit, the present algorithm can utilize data from an Advertiser estimating the relationship between: (a) the amount and/or type of Advertisement Inventory purchased by an Advertiser; and (b) variables affecting Total Profit, including, but not limited to:

Total Product Sales

Distribution of Sales by Type of Product Purchased by Customers

Distribution of Sales by Geography of Customer Purchase (if an Advertiser cannot determine the geography of each individual consumer, the present method can enable an Advertiser to define the geography of consumers in groups or by broad categories like zip code, city, county, state, region, or country)

Distribution of Sales Among Channels Through Which Customers Purchase Product

Distribution of Sales Among Customers Requiring Different Level of Service

Distribution of Sales Among Customers With Different Financing Costs

In one embodiment, find the optimum or close to optimum combination of the values of the Profit Maximization Variables that maximizes the following objective function:

Total Profitₘₐₓ=[(Total Product Sales), where Total Product Sales can be calculated in a variety of ways, including, but not limited to:
i. Total Product Sales=A
((Σ Unitsₐ*(SOIₐ)*(average Unit Price of Product)
a=1

where a=any given Advertisement Inventory from an Operator purchased by Advertiser, and

A=number of Advertisement Inventory from all Operators purchased by Advertiser)

In other words, Total Product Sales should equal the sum of the product of: (a) the number of units of advertisements from any given Advertisement Inventory from an Operator purchased by Advertiser; (b) the ratio of the number of unit sales to the unit number of advertisements viewed over some time period for the Product Category specified by Advertiser for any given Advertisement Inventory purchased by Advertiser; and (c) the average Unit Price of Product.
ii. Total Product Sales=(A
*(average SOIₐ for the Product Category specified by Advertiser)
*(average Unit Price of Product)

where a=any given Advertisement Inventory from an Operator purchased by Advertiser, and

A=number of Advertisement Inventory from all Operators purchased by Advertiser)

In other words, Total Product Sales should equal the product of: (a) the total number of units of advertisements purchased by an Advertiser; (b) the ratio of the total number of unit sales to the total unit number of advertisements viewed over some time period for the Product Category specified by Advertiser for any given Advertisement Inventory purchased by Advertiser; and (c) the average Unit Price of Product. The present algorithm assumes that the average SOIₐ for the Product Category specified by Advertiser observed from a sample group, estimated from a model, or estimated from any other method accurately or approximately reflects the true SOI. If not, the present algorithm would not utilize this product. The present algorithm can determine if the average SOIₐ accurately or approximately reflects the true SOI by comparing said SOIₐ with historical SOIₐ. If the difference is within a range specified by Advertiser, the present algorithm can utilize this product.]

less
A

[(Σ((Unit Ad Costₐ)*(Unitsₐ))
a=1

where a=any given Advertisement Inventory from an Operator purchased by Advertiser, and

A=number of Advertisement Inventory from any Operator purchased by Advertiser)
P

+(Σ((Unit Manuf Costₚ)*(Sale of Unitsₚ))
p=1

where p=Type of Product, and P=number of Types of Product)
G

+(Σ(D_{g}−D_{dc})
g=1

where D is the cost to deliver the product to any given customer,

g=geographical location of any given customer,

G=number of customers purchasing product, and

dc=geographical location of Advertiser's distribution center closest to said customer)
P

+(Σ((Inventory Costₚ)*(Sale of Unitsₚ))
p=1

where p=Type of Product, and

P=number of Types of Product)

+(Σ((Unit Marketing Cost)*(Sale of Units))

+(Σ((Unit Selling Costₛ₁)*(Sale of Unitsₛ₁))+((Unit Selling Costₛ₂)*(Sale of Unitsₛ₂))

+((Unit Selling Costₛ₃)*(Sale of Unitsₛ₃))+((Unit Selling Costₛ₄)*(Sale of Unitsₛ₄))+((Unit Selling Costₛ₅)*(Sale of Unitsₛ₅))

where

s1 is physical retail channel,

s2 is online retail channel,

s3 is phone retail channel,

s4 is direct mail retail channel, and

s5 is any other retail channel)
V

+((Σ((Unit Service Costᵥ)*(Sale of Unitsᵥ)))
v=1

+(Cost to Service Consumers who Inquire About Product, but Do Not Purchase Product), where v=any given Type of Customer Requiring Different Level of Service, and

V=number of Types of Customer Requiring Different Level of Service)
F

+(Σ((Unit Financing Cost_{f})*(Sale of Units_{f}))
f=1

where f=any given Type of Customer With Different Financing Costs, and

F=number of Types of Customer With Different Financing Costs)]

Subject to the following constraints of:
A

A=Σ(Unitsₐ)
a=1
P

Total Product Sales=Σ(Sale of Unitsₚ)
p=1

Total Product Sales=Σ(Sale of Unitsₛ₁+Sale of Unitsₛ₂+Sale of Unitsₛ₃+Sale of Unitsₛ₄+Sale of Unitsₛ₅)
V

Total Product Sales=Σ(Sale of Unitsᵥ)
v=1
F

Total Product Sales=Σ(Sale of Units_{f})
f=1

The present algorithm in Step A18 can include a subset of the above terms in the objective function, other or additional terms in the objective function (e.g., any other terms that describe additional costs faced by an Advertiser related to the purchase of Advertisement Inventory), equivalent or related terms in the objective function, other or additional Profit Maximization Variables included in the objective function, equivalent or related Profit Maximization Variables included in the objective function, a subset of the above constraints, other or additional constraints, and/or equivalent or related constraints.

The present application notes that an Advertiser should know all the terms in the above equation for Total Profitₘₐₓ except for Unitsₐ, Unitsₚ, Unitsₛ₁₋ₛ₅, Unitsᵥ, Units_{f}, and D_{g}.

The present invention can utilize a variety of approaches (“Solution Methods”) that are well known to those skilled in the art to find the optimum or close to optimum combination of the values of the Profit Maximization Variables that maximize Total Profitₘₐₓ, including, but not limited to: branch and bound methods; interior point methods; gradient descent/ascent methods; methods based on real algebraic geometry; simulated annealing algorithm; Monte Carlo method; genetic algorithm; particle swarm optimization method; ant colony optimization method.

One exemplary method of implementing the present algorithm in Step A18 is to utilize the genetic algorithm to find the optimum or close to optimum combination of values of the Profit Maximization Variables that maximize Total Profitₘₐₓ. The genetic algorithm method is well known in the programming art. The following description illustrates how to implement the present algorithm in Step A18 using the genetic algorithm. The example should illustrate to any person skilled in the art how to make and use the present algorithm in Step A18 utilizing other methods to find the optimum or close to optimum combination of the values of the Profit Maximization Variables that maximize Total Profitₘₐₓ.

First, define each chromosome as a n bit-string representing a single candidate solution, i.e., one unique combination of Unitsₐ, e.g., the units of Advertisement Inventory selected in the example of Step A17.h, Unitsₚ, Unitsₛ₁₋ₛ₅, Unitsᵥ, Units_{f}, and D_{g}.

Second, randomly generate an initial population of chromosomes, i.e., solutions.

Third, calculate the fitness of each chromosome, where fitness is the measure of how well each chromosome maximizes Total Profitₘₐₓ.

Fourth, retain only the most fit chromosomes and discard the least fit chromosomes.

Fifth, generate a new population of chromosomes from the remaining chromosomes by a variety of operators, including, but not limited to: reproduction, crossover, or mutation.

Sixth, repeat steps (third). through (fifth).

Seventh, halt after the genetic algorithm reaches one of the following conditions, including, but not limited to: a predetermined number of generations, a predetermined amount of time, or if there is no change in the best solution after a predetermined number of generations.

Eighth, purchase those Unitsₐ constituting the best solution.

Unlike the algorithm described in Step A17, the present algorithm in Step A18 does not necessarily select the available Advertisement Inventory ranking highest in Profit Margin. There may be some Advertisement Inventory that generates a higher difference between Unit Revenues and Unit Ad Costs and yet contribute a lower amount to the Total Profit of an Advertiser than other Advertisement Inventory, because purchasing the former Advertisement Inventory could generate higher costs of manufacturing, distribution, inventory, marketing, selling, customer service, and/or financing.

Typically, an Advertiser decides first on the amount of the Budget (Ad) and then decides how to allocate said budget among the different Media Channels, Operators, Programs/Pages, and/or Spaces. If an Advertiser wants to set a fixed Budget (Ad), the present algorithm in Step A18 would add the following constraints to the above list of constraints:

Budget (Ad)=Amount determined by Advertiser
A

Budget (Ad)=Σ((Unit Ad Costₐ)*(Unitsₐ))
a=1

Instead of an Advertiser setting a fixed Budget (Ad), the present algorithm can find the Budget (Ad) as well as the Optimal Advertisement Inventory Selected that maximizes Total Profit. The present invention can generate an optimum Budget (Ad) which could exceed the Budget (Ad) spent by an Advertiser or exceed even the revenues of an Advertiser. If an Advertiser can increase Total Profit by increasing Budget (Ad) beyond current levels or even current revenues, an efficient capital market should fund said increase in Budget (Ad) through providing an Advertiser access to equity and/or debt.

If an Advertiser wants to allow the Budget (Ad) to vary along with the other Profit Maximization Variables, the present algorithm in Step A18 would determine the optimum or close to optimum size of the Budget (Ad) that maximizes Total Profit.

The present algorithm in Step A18 can enable an Advertiser to incorporate the data collected on the Intermediate Results for each Media Channel, Operator, Program/Page, and/or Space by substituting or adding said data to determine the effectiveness of any given Advertisement Inventory. Said process can enable an Advertiser to sort the list of available units of Advertisement Inventory not only by the effectiveness of each Media Channel, Operator, Program/Page, and/or Space in generating sales, but also in generating Intermediate Results.

The present invention differs from prior art by enabling an Advertiser to set the size of the Budget (Ad) that maximizes Total Profit, rather than set the Budget (Ad) based on a certain percentage of revenues, a percentage of revenues comparable to the level allocated by competition, a percentage increase/decrease from the prior period's Budget (Ad), or some other arbitrary method. The present algorithm in Step A18 can enable an Advertiser to maximize Total Profit, because it utilizes data measuring the effectiveness of a marginal dollar spent on an advertisement, i.e., SOI or IROI, which helps an Advertiser determine how much it should spend on the Budget (Ad) and how to allocate most efficiently said Budget (Ad) among the different Media Channels, Operators, Programs/Pages, and/or Spaces.

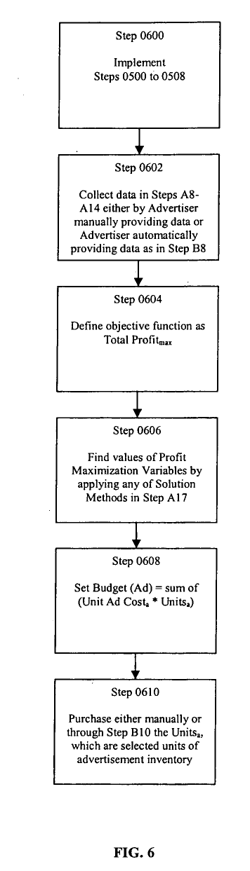

FIG. 6 is a flow chart of one embodiment of the present system optimizing allocation of an advertisement budget considering the cost to purchase Advertisement Inventory and other costs of an Advertiser. Understanding of FIG. 6 will be apparent to persons skilled in the relevant arts based on the teachings provided herein.

The present invention can implement the system and the above algorithms by executing a subset of the above steps, executing a plurality of the substeps within any given step, executing said steps in different order, executing other or additional steps, and/or executing equivalent or related steps.

In one embodiment, the present invention can maximize over any time period Total Profits. In other embodiments, the present invention can maximize over any time period any other measure preferred by an Advertiser, including, but not limited to: operating income; net income; cash flow; free cash flow; earnings before interest, taxes, depreciation, and amortization; or any other proxy for Total Profits.

In another embodiment, an Advertiser can implement fewer of the above steps, which would be a system that would probably be less likely to maximize Total Profit, but be simpler.

Automation of Method and Integration with Advertiser and Operator Internal Systems

In another embodiment, instead of having an Advertiser manually input data regarding its costs, e.g., the data collected in Steps A8-A15, the present invention can determine automatically the optimum size of an advertising budget and/or optimize automatically the allocation of an advertising budget to maximize sales and/or profits by linking to hardware, software, and/or databases of a Sales Measurement System; hardware, software, and/or databases of Operators that contain data regarding the availability, quality, quantity, and/or costs of Advertisement Inventory; and Advertisers that contain data regarding its costs, e.g., the data collected in Steps A8-A15. In this embodiment, the present invention can link the computer(s) and algorithm(s) to the internal hardware, software, and/or databases of Sales Measurement Systems, Operators, and Advertisers containing said data, including, but not limited to: enterprise resource planning (ERP) system or software, supply chain management software, demand chain management software, manufacturing optimization software, distribution optimization software, inventory control software, human resource planning software, sales force optimization software, customer relationship management software, and/or financial accounting software.

The present system can transmit and/or receive data from a variety of sources, which can couple to the present system through any type of network, including, but not limited to: a LAN and/or a WAN, e.g., the Internet. The present system can transmit and/or receive data to and/or from sources through open interfaces or non-open or proprietary interfaces, in which case the present system can convert the format of the data to become compatible with the present system.

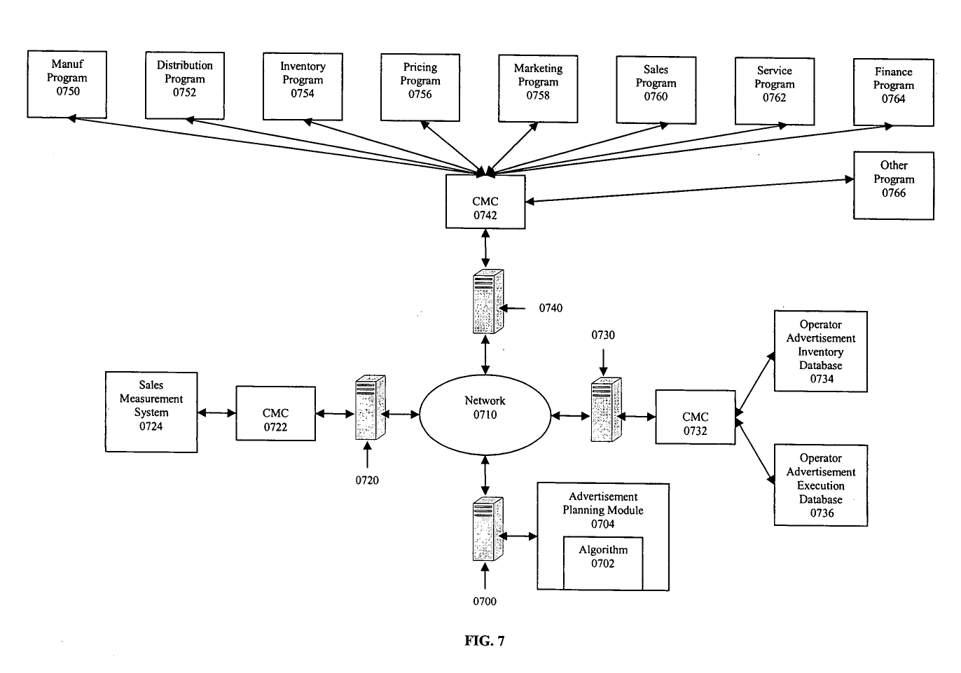

FIG. 7 is a block diagram illustrating the structural and functional interrelationships of an exemplary system of the present invention connecting with the hardware, software, and/or databases of an Advertiser to allocate automatically an advertising budget. The present system can implement with the following components, including, but not limited to: Server 0700, Algorithm 0702, Advertisement Planning Module 0704, Network 0710, Third Party Server 0720, Communication Middleware Component 0722, Sales Measurement System 0724, Operator Server 0730, Communication Middleware Component 0732, Operator Advertisement Inventory Database 0734, Advertiser Server 0740, Communication Middleware Component 0742, and/or Advertiser Data Programs, which can include, but are not limited to: Manufacturing Program 0750, Distribution Program 0752, Inventory Program 0754, Pricing Program 0756, Sales Program 0760, Service Program 0762, Finance Program 0764, and/or Other Program 0766. The present system can implement each of these components as computer programs executing in one or more computers performing the reception, processing, storage, and/or transmission of data. The present system can exchange data through open standards, e.g., exchange of HyperText Markup Language (HTML) or eXtensible Markup Language (XML) documents, or non-open or proprietary standards. The present system can implement each of these components in a variety of ways, including, but not limited to: implement on a single device, e.g., a computer; and/or implement across multiple devices, including computers, which are connected through a network. A component can be a single application or comprise more than one application which collectively performs the functions of said component. A component can include software systems, which can include any software, application, and/or computer program product implemented on one or more computers.

Server 0700 can include a computer- or machine-readable media storing thereon instructions which can program a computer or other hardware to perform Steps A1-A17, equivalent or related steps, other or additional steps, or any subset thereof.

Algorithm 0702 can include any type of algorithm that can find the optimum or close to optimum combination of the values of the Profit Maximization Variables that maximize Total Profit, including, but not limited to: the algorithm described in Steps A16 or A17.

Advertisement Planning Module 0704 can query other software, application, and/or database to retrieve data utilized by Steps A1-A17; execute a purchase of Advertisement Inventory by Advertiser; and measure if Operator displayed any given unit of Advertisement Inventory purchased by Advertiser.

Network 0710 can include any type of network, including, but not limited to: a LAN and/or a WAN, e.g., the Internet.

Third Party Server 0720 can include a computer- or machine-readable media storing instructions which can program a computer or other hardware to perform the functions enabled by Communication Middleware Component 0722.

Communication Middleware Component 0722 can perform functions enabling Server 0700 or any other server external to a Sales Measurement System 0724 network to communicate with said system. These functions can include, but are not limited to: transmitting data to and/or receiving data from Sales Measurement System 0724; authenticating sources of data; storing, retrieving, and/or archiving data; decrypting/encrypting data; and/or enforcing any security policy for any data transmitted or received by Third Party Server 0720.

Sales Measurement System 0724 can include a computer program product which can generate, collect, analyze, and exchange data utilized in Steps A1-A6.

Operator Server 0730 can include a computer- or machine-readable media storing instructions which can program a computer or other hardware to perform the functions enabled by Communication Middleware Component 0732.

Communication Middleware Component 0732 can perform functions enabling Server 0700 or any other server external to an Operator network to communicate with said Operator. These functions can include, but are not limited to: transmitting data to and/or receiving data from Operator Advertisement Inventory Database 0734; authenticating sources of data; storing, retrieving, and/or archiving data; decrypting/encrypting data; and/or enforcing any security policy for any data transmitted or received by Operator Server 0730.

Operator Advertisement Inventory Database 0734 can include a computer program product which can contain data utilized by Algorithm 0702, which can include, but is not limited to: availability, quality, quantity, and/or cost of Advertisement Inventory.

Operator Advertisement Execution Database 0736 can include a computer program product which can contain data identifying if Operator displayed any given unit of advertisement purchased by Advertiser. Said database can contain one or more records for each unit of advertisement purchased by Advertiser containing data including, but not limited to: the price paid for said unit, and the display of said unit. For example, a Magazine Operator can have a database 0736 which includes a record for a unit of a full page Advertisement Inventory in a given monthly issue purchased by a given Advertiser, a price of $50,000 paid by said Advertiser, and data indicating that an advertisement produced by said Advertiser displayed in said monthly issue.

Advertiser Server 0740 can include a computer- or machine-readable media storing instructions which can program a computer or other hardware to perform the functions enabled by Communication Middleware Component 0742.

Communication Middleware Component 0742 can perform functions enabling Server 0700 or any other server external to an Advertiser network to communicate with an Advertiser Data Programs. These functions can include, but are not limited to: transmitting data to and/or receiving data from Advertiser Data Programs; authenticating sources of data; storing, retrieving, and/or archiving data; decrypting/encrypting data; and/or enforcing any security policy for any data transmitted or received by Server 0740.

Manufacturing Program 0750 can include any software, application, database, and/or computer program product receiving, collecting, processing, storing, and/or transmitting data described in Step A8.

Distribution Program 0752 can include any software, application, database, and/or computer program product receiving, collecting, processing, storing, and/or transmitting data described in Step A9.

Inventory Program 0754 can include any software, application, database, and/or computer program product receiving, collecting, processing, storing, and/or transmitting data described in Step A10.

Pricing Program 0756 can include any software, application, database, and/or computer program product receiving, collecting, processing, storing, and/or transmitting data described in Step A11.

Marketing Program 0758 can include any software, application, database, and/or computer program product receiving, collecting, processing, storing, and/or transmitting data described in Step A12.

Sales Program 0760 can include any software, application, database, and/or computer program product receiving, collecting, processing, storing, and/or transmitting data described in Step A13.

Service Program 0762 can include any software, application, database, and/or computer program product receiving, collecting, processing, storing, and/or transmitting data described in Step A14.

Finance Program 0764 can include any software, application, database, and/or computer program product receiving, collecting, processing, storing, and/or transmitting data described in Step A15.

Other Program 0766 can include any software, application, database, and/or computer program product receiving, collecting, processing, storing, and/or transmitting any other data that could affect the values of the Profit Maximization Variables in Step A18.

In one embodiment, the present invention can implement any combination or subset of the following, equivalent, or related steps.

B1. Implement Step A1.

B2. Implement Step A2.

B3. Implement Step A3.

B4. Implement Step A4.

The present method can request the data utilized in Steps B1-B4 by transmitting a request, query, and/or call through Network 0710 to Third Party Server 0720 through Communication Middleware Component 0722 to Sales Measurement System 0724 for data identified in Steps B1-B4. In response to said request, Sales Measurement System 0724 can transmit the requested data to Server 0700 for processing by Algorithm 0702.

B5. Implement Step A5.

B6. Implement Step A6.

B7. Advertisement Planning Module 0704 stored on Server 0700 can transmit a request, query, and/or call through Network 0710 to Operator Server 0730 through Communication Middleware Component 0732 to Operator Advertisement Inventory Database 0734 for data on unit cost and/or total cost of purchasing any given advertisement. In response to said request, Operator Inventory Database 0734 can transmit the requested data to Server 0700 for processing by Algorithm 0702.

B8. Advertisement Planning Module 0704 stored on Server 0700 can transmit a request, query, and/or call through Network 0710 to Advertiser Server 0740 through Communication Middleware Component 0742 to a specific Advertiser Data Program for any data utilized by Steps A8-A15. For example, the present method can request data on unit and/or total manufacturing costs from Manufacturing Program 0750. Alternatively, the present method can request data on unit and/or total manufacturing costs from Other Program 0766, which can include an Advertiser's internal financial reporting program that can contain unit and/or total manufacturing costs as a function of sales of product. Said internal financial report program can contain any or all of the cost data collected by Steps A8-A15. In response to said request, Advertiser Data Program can transmit the requested data to Server 0700 for processing by Algorithm 0702.

The present method can query any database and retrieve any data utilized by Steps A8-A15 through a variety of processes that are well known to those skilled in the art. These processes can include, but are not limited to: enterprise information integration (EII), or enterprise application integration (EAI), enterprise content integration, virtual database, federated query systems, and federated data management. These processes can enable the present method to transmit, receive, and/or exchange data in a variety of ways, including, but not limited to: creating an intermediate data services layer, also known as middleware, that permits access to data in a standard format, or access said data directly. These processes can utilize any kind of method for facilitating the exchange of data across different platforms, including, but not limited to: any open standard, e.g., XML or electronic data interchange (EDI), or any non-open or proprietary standard. These processes can exchange data in a variety of ways, including, but not limited to: exchanging data directly, or utilizing metadata repositories or catalogs which contain any relevant information about data, including, but not limited to: the availability of data, the location of data, and/or the relationship among data. These processes can transmit, receive, and/or exchange data, files, or any other information utilizing any transport protocol, including, but not limited to: HTTP or FTP.

B9. Algorithm 0702 utilizes the data retrieved in Steps B1-B8 and processes said data in accordance with Steps A15, A16, and/or A17, where appropriate.

B10. Advertisement Planning Module 0704 stored on Server 0700 can purchase the Advertisement Inventory selected by Algorithm 0702 which maximizes Total Profit, e.g., the Advertisement Inventory selected by Step A17,h, or Optimal Advertisement Inventory Selected identified by Step A18. Advertisement Planning Module 0704 can automatically debit/credit an Operator's billing software and/or an Advertiser's financial accounting software to enable said purchase.

B11. Advertisement Planning Module 0704 can measure if Operator(s) displayed advertisements purchased by Advertiser by linking to Operator Advertisement Execution Database 0736 to any specific record and/or field indicating if Operator displayed said advertisements. Advertisement Planning Module 0704 can utilize any method for querying and retrieving data regarding display of said advertisements from a database that is well known to those skilled in the art.

The present method can implement Steps B1-B11 by retrieving data from Sales Measurement System 0724, Operator Advertisement Inventory Database 0734, and/or Advertiser Data Programs and processing said data in Algorithm 0702 on Server 0700. In another embodiment, the present method can implement Steps B1-B11 by having Advertiser Server 0730 or any other server operated by an Advertiser retrieve data from Server 0700, Sales Measurement System 0724, and/or Operator Advertisement Inventory Database 0734 and process said data in Algorithm 0710 on Server 0730 or any other server operated by an Advertiser. That is, instead of a third party retrieving data from Sales Measurement System 0724, Operators, and an Advertiser to process said data, an Advertiser can retrieve and process said data directly. In another embodiment, the present method can implement Steps B1-B11 as a module internal to an Advertiser's hardware, software, and databases as part of its ERP as described in the next section, “Integration with Advertiser Enterprise Resource Planning System.”

By automating the linkage of Algorithm 0710 to the Advertiser Data Programs, the present system and method can automatically determine the optimum size of an advertising budget and/or optimize the allocation of an advertising budget to maximize sales and/or profits. The present system and method can automate this process so that even if any given cost function changes, the present system and method can determine an optimum size of an advertising budget and/or optimize the allocation of an advertising budget to reflect said changes. For example, an Advertiser can experience an increase in the cost of shipping goods to a consumer. All other things remaining equal, such increase could reduce the profitability of a sale through the direct mail or online retail channels relative to the profitability of a sale through a physical retail channel. Under this assumption, an Advertiser could prefer to allocate a higher percentage of its advertising budget to Media Channels, Operators, Programs/Pages, and/or Spaces which direct a consumer to purchase its product through a physical retail channel. In addition, an Advertiser could prefer to change the content of an advertisement to encourage consumers to purchase its products through a physical retail, instead of a direct mail or online retail, channel. For example, a television advertisement could include directions to a local physical retailer, instead of a link to the online retail channel.

Integration with Advertiser Enterprise Resource Planning System

Companies utilize ERP systems because they integrate data and programs across an entire enterprise to enable, inter alia, data sharing, order management, and resource planning. Companies have generally integrated a variety of programs and databases for functions including, but not limited to: manufacturing, purchasing, inventory, distribution, sales force management, customer relationship management, information technology, human resources, finance, and accounting. However, companies do not integrate advertising planning and purchasing decisions into ERP systems. An Advertiser's decision on the amount and distribution of advertisement purchases can have significant implications for the scheduling and allocation of resources for many, if not all, of the above functions. For example, a large purchase of advertisements encouraging consumers to buy product by a certain date can affect inventory in manufacturing, warehouses, and retailers. A purchase of advertisements in a certain geographical region or through a certain sales channel can affect the availability of inventory in said geographical region or the resources needed in said sales channel. A large purchase or effective purchase of advertisements can affect the resources needed for customer service to handle incoming calls and emails. A large or effective purchase of advertisements can increase consumer web requests to an

Advertiser's web server and affect the amount of bandwidth or storage needed to serve said requests.

The present invention can include a system and method for integrating: (a) software, application, database, and/or computer program product determining the size of an advertising budget, the allocation of an advertising budget, and/or the type of advertisements produced and purchased; with (b) the other programs or applications of an Advertiser.

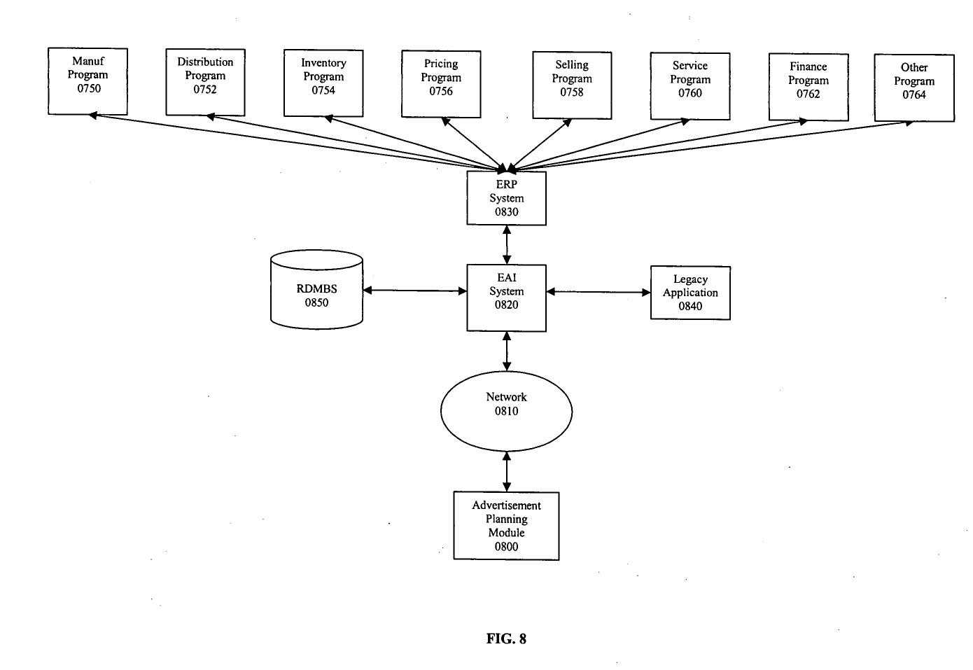

FIG. 8 is a block diagram illustrating the structural and functional interrelationships of an exemplary system of the present invention connecting an advertisement planning application with one or more ERP and other applications and databases of an advertiser.

Advertisement Planning Module 0800 can include any software, application, database, and/or computer program product performing any or all of the functions described in Steps A1-A17 and/or Steps B1-B11. Advertisement Planning Module 0800 can be located externally to the Advertiser's hardware, software, and/or databases and/or internally as part of the Advertiser's hardware, software, and/or databases. Advertisement Planning Module 0800 can be a single application or comprise more than one application which collectively performs the functions of said module. The present system can implement Advertisement Planning Module 0800 in a variety of ways, including, but not limited to: implement on a single device, e.g., a computer; and/or implement across multiple devices, including computers, which are connected through a network. The present system can implement Advertisement Planning Module 0800 and enable an Advertiser to access said module through a network, e.g., the Internet.

Network 0810 can include any type of network, including, but not limited to: a LAN and/or a WAN, e.g., the Internet.

EAI System 0820 can include any software application designed to integrate or link disparate software applications and enable them to communicate utilizing open interfaces or non-open or proprietary interfaces. EAI System 0820 can enable software applications, including Application Planning Module 0800, to communicate among each other through a variety of processes that are well known to those skilled in the art. In one embodiment, EAI System 0820 can utilize message objects for handling application requests for data; adapters for producing, extracting, transmitting, and/or receiving requests for data; and transformers for transforming messages containing data extracted from one or more applications into messages containing data needed by one or more other applications.

ERP System 0830 can include one or more of any software application(s) designed to integrate software applications performing specific functions, e.g., manufacturing, inventory, human resources, or finance, to enable communication and synchronization. ERP System 0830 can integrate modules which can include, but are not limited to: Manufacturing Program 0750, Distribution Program 0752, Inventory Program 0754, Pricing Program 0756, Sales Program 0760, Service Program 0762, Finance Program 0764, and/or Other Program 0766.

Legacy Application 0840 can include any existing software application(s) utilized by an enterprise designed to perform a specific function, e.g., manufacturing, inventory, human resources, or finance.

Relational Database Management System (RDBMS) 0850 can include any one or more of any databases storing data utilized by any software application, including, but not limited to: Advertisement Planning Module 0800, EAI System 0820, ERP System 0830, and/or Legacy Application 0840.

The present system can be a computer program product which can include a computer- or machine-readable media storing thereon instructions which can program a computer or other hardware to perform the following method or process in one embodiment.

C1. Advertisement Planning Module 0800 determines the optimum size of an advertising budget and/or the optimum allocation of an advertising budget.

C2. Advertisement Planning Module 0800 communicates the parameters of the advertising budget and advertising budget allocation to ERP System 0830 through Network 0810 and EAI System 0820.

C3. ERP System 0830 communicates said parameters to the respective modules whose schedule, resources, and costs would be affected by said advertisement parameters.

C4. Respective modules, e.g., Manufacturing Program 0750, adjust their schedule and resources to support the orders and sales forecasted by the purchase of a given advertising budget and/or allocation of an advertising budget.

In another embodiment, Advertisement Planning Module 0800 can communicate the parameters of the advertising budget and advertising budget allocation directly to ERP System 0830 through Network 0810 without need for EAI System 0820. In another embodiment, Advertisement Planning Module 0800 can be another module that operates internally and along with modules 0750 through 0766 constitute an ERP System 0830. In this embodiment, Advertisement Planning Module 0800 can retrieve data from Sales Measurement System 0724, Operator Advertisement Inventory Database 0734, and/or any other necessary data through Network 0810 from an Advertiser's internal hardware, software, and databases.

The present system can produce the following useful, concrete, and tangible results:

Generate data on the analysis of available Advertisement Inventory, the purchase of Advertisement Inventory, and the analysis of the effectiveness of purchasing any given Advertisement Inventory, e.g., the impact that said purchase can have on sales and/or profits of an Advertiser. The present system can enable an Advertiser to determine which Advertisement Inventory is most effective in increasing sales and/or profits of an Advertiser.

Generating data enabling an Advertiser to determine the effectiveness of past advertising campaigns in order to design and produce more effective advertising campaigns.

Integrate data on the analysis, purchase, and evaluation of Advertisement Inventory with other data and software applications of an Advertiser to improve productivity. For example, the present system can link the decisions made by Advertisement Planning Module 0800 on the optimum size of an advertising budget to a given level and/or the optimum allocation of an advertising budget with ERP System 0830 as follows:

Manufacturing. Advertisement Planning Module 0800 can communicate said sales forecast to Manufacturing Program 0750 to alert the manufacturing department to adjust purchasing and manufacturing to produce output that can support said sales.

Distribution. Advertisement Planning Module 0800 can communicate said sales forecast to Distribution Program 0752 to alert the distribution department and any external distribution partners (e.g., warehouses and shippers) to adjust distribution and supply chain to support said sales.

Inventory. Advertisement Planning Module 0800 can communicate said sales forecast to Inventory Program 0754 to alert the inventory department to adjust inventory levels to support said sales.

Information Technology. Advertisement Planning Module 0800 can communicate forecasts of sales and/or customer Internet visits to the IT department and any external IT partners (e.g., web hosting) to adjust IT and web capabilities to support said sales and/or visits.

Pricing. Advertisement Planning Module 0800 can communicate said sales forecast to Pricing Program 0756 to alert the marketing department potentially to adjust pricing to reflect high or low demand.

Marketing. Advertisement Planning Module 0800 can communicate said sales forecast to Marketing Program 0758 to alert the marketing department to adjust non-advertising resources to support said sales.

Sales. Advertisement Planning Module 0800 can communicate said sales forecast to Sales Program 0760 to alert the sales department to adjust sales channel resources to support said sales.

Customer Service. Advertisement Planning Module 0800 can communicate said sales forecast to Service Program 0762 to alert the customer service department to adjust customer service resources to support said sales.

Finance. Advertisement Planning Module 0800 can communicate said sales forecast to Finance Program 0764 to alert the finance department to adjust finance resources to support said sales and integrate Advertisement Inventory purchases with financial accounting software application.

Online Media Buying

The present invention includes an online system to: (a) enable an Advertiser to input data regarding its advertising campaign; (b) one or more Operators to input data regarding their Advertisement Inventory; (c) select the optimum size of an advertising budget and/or optimize the allocation of an advertising budget among different Media Channels, Operators, Programs/Pages, and/or Spaces; and/or (d) enable an Advertiser to purchase the Advertisement Inventory selected by the present system.

The present invention can enable an Advertiser to input certain data needed by the present invention to determine the optimum size of an advertising budget and/or optimize the allocation of an advertising budget among the different Media Channels, Operators, Programs/Pages, and/or Spaces. The parameters of an advertising campaign can include, but are not limited to: the Product Category of the product promoted in the advertising campaign, the advertising budget, the characteristics of the target customer, and the desired timing of advertisement placement. After inputting these parameters, the present invention can utilize the system and/or method embodied in Steps A1-A17 to generate an optimum size of an advertising budget and/or an optimum allocation of said budget which generates the highest ratio of sales on invested capital, maximum sales, and/or maximum profits.

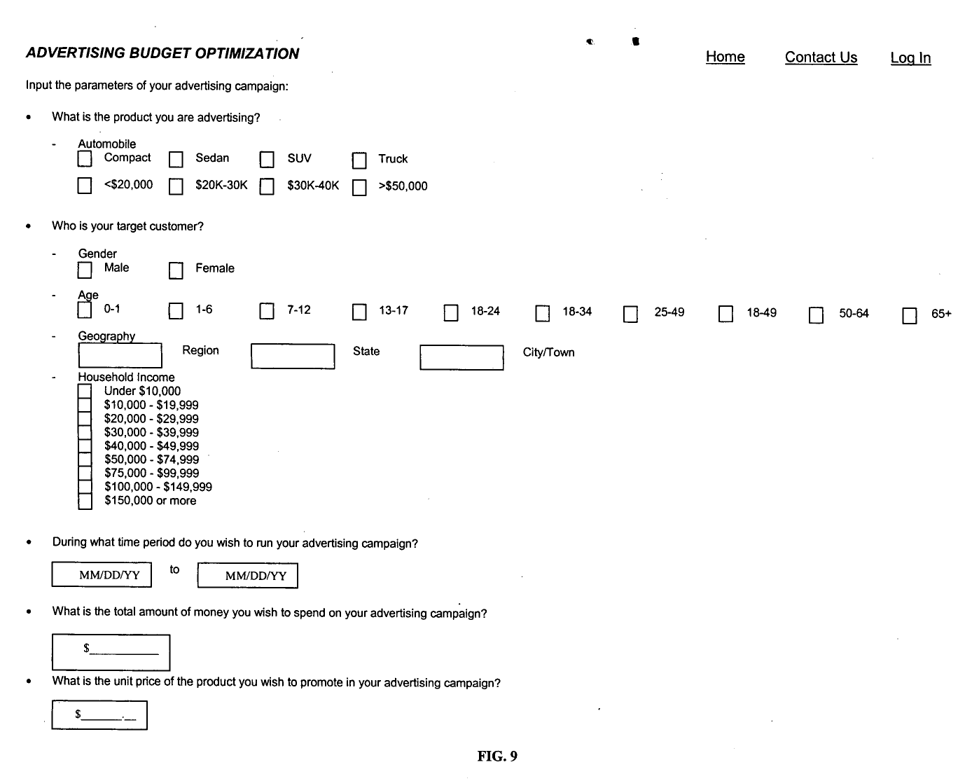

FIG. 9 illustrates an example of a web page providing an Advertiser the ability to input the above parameters of an advertising campaign. The present invention can enable the construction and operation of said web page through a variety of processes that are well know to those skilled in the art. The exemplary web page includes only a sample of the parameters and the options for each parameter which an Advertiser can input. For example, while the exemplary web page displays only one Product Category, Automobile, the present invention can enable an Advertiser to select among any number of possible Product Categories. After inputting said parameters, the present invention can collect and process the data described in Steps A1-7, A15 and apply the algorithm described in Step A17 to determine the optimum allocation of an advertising budget among the different Media Channels, Operators, Programs/Pages, and/or Spaces.

To apply the algorithm described in Step A18, an Advertiser would need to input additional data described in Steps A8-A15. After said inputting, the present invention can apply the algorithm described in Step A18 to determine the optimum size of an advertising budget and/or optimize the allocation of an advertising budget among the different Media Channels, Operators, Programs/Pages, and/or Spaces.

In another embodiment, the present invention can utilize Steps B1-B11 to retrieve the data needed to apply the algorithms described in either Step A17 or A18. For example, if Advertiser inputs the Product Category of the product promoted in the advertising campaign, the method implemented in Steps B1-B11 can automatically determine the optimum size of an advertising budget and/or optimize the allocation of an advertising budget among the different Media Channels, Operators, Programs/Pages, and/or Spaces.

The present invention can enable Operators to offer online the availability of Advertisement Inventory on their Programs/Pages and/or Spaces; enable an Advertiser to bid online to advertise on said Programs/Pages and/or Spaces; and/or match Advertisers and Operators to execute the purchase of said Advertisement Inventory.

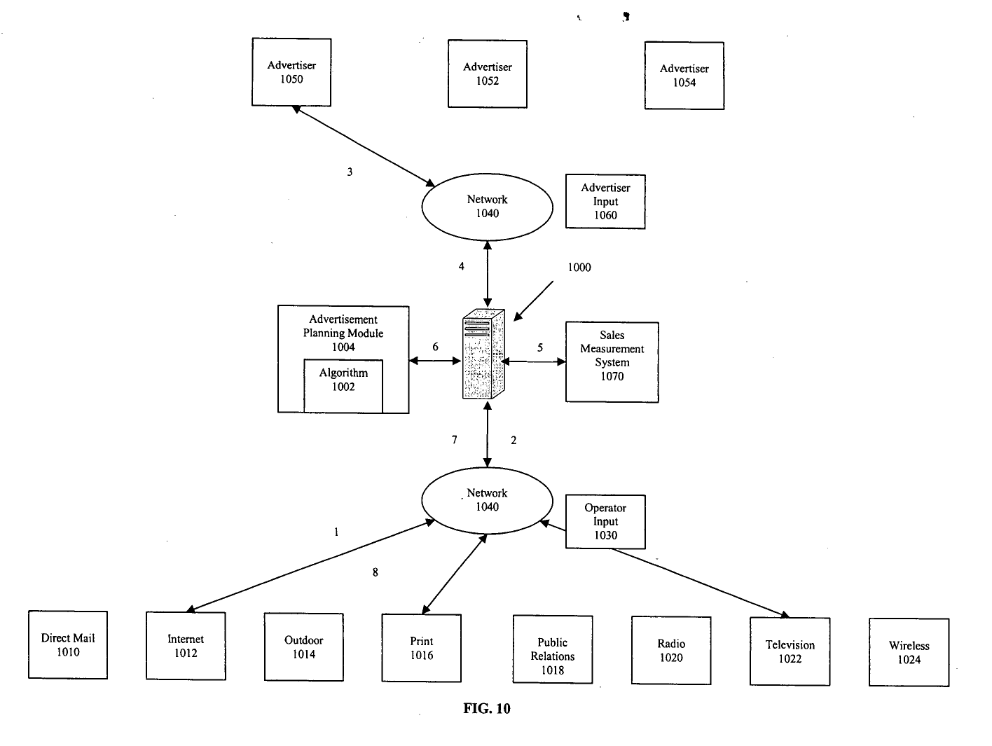

FIG. 10 is a block diagram illustrating the structural and functional interrelationships of an exemplary system of advertisers, different media channels and operators, and third parties enabling online media buying.

Server 1000 can include a computer- or machine-readable media storing thereon instructions which can program a computer or other hardware to perform Steps A1-A18, Steps B1-B11, equivalent or related steps, other or additional steps, or any subset thereof.

Algorithm 1002 can include any type of algorithm that can find the optimum or close to optimum combination of the values of the Profit Maximization Variables that maximize Total Profit, including, but not limited to: the algorithm described in Steps A17 or A18.

Advertisement Planning Module 1004 can query other software, application, and/or database to retrieve data utilized by Steps A1-A18; manage an online media buying service as described in the present system, execute a purchase of Advertisement Inventory by Advertiser; and measure if Operator displayed any given unit of Advertisement Inventory purchased by Advertiser.

Operators can include, but are not limited to: Direct Mail Operator 1010, Internet Operator 1012, Outdoor Operator 1014, Print Operator 1016, Public Relations Operator 1018, Radio Operator 1020, Television Operator 1022, and/or Wireless Operator 1024.

Any of said Operators can offer online the availability, pricing, and/or other parameters of Advertisement Inventory by transmitting said parameters in any file, e.g., Operator Input 1030, to Advertisement Planning Module 1004 through Network 1040.

Network 1040 can include any type of network, including, but not limited to: a LAN and/or a WAN, e.g., the Internet.

Advertiser 1050 can input the parameters of an advertising campaign, input any data described in Steps A8-A15, and/or bid for any available Advertisement Inventory by transmitting said parameters in any file, e.g., Advertiser Input 1060, to Advertisement Planning Module 1004 through Network 1040.

Sales Measurement System 1070 can transmit any data it generates, collects, analyzes, and exchanges for utilization in Steps A1-A6.

General Information

While the present invention includes algorithms that specify the steps involved, the present invention can utilize numerous variations of said algorithms, which fall within the scope of the invention.

The present application includes headings herein for reference and to aid in locating certain sections. The present application does not intend these headings to limit the scope of the concepts described therein. The present application may apply said concepts in other sections throughout the entire specification.

While the present application describes how to format data, assign names to variables, and assign names to values that are written in the English language, said data, variables, and values can be written in alternative languages. The present invention can include modification of the systems, methods, and apparatus to operate with data, variables, and values in languages different from English.

The present application provides the previous description of the disclosed embodiments to enable any person skilled in the art to make and use the present invention. Various modifications to these embodiments will be readily apparent to those skilled in the art. The present invention may apply the generic principles defined herein to other embodiments without departing from the spirit or scope of the invention. Thus, the present application does not intend to limit the present invention to the embodiments shown herein, but accords the widest scope consistent with the principles and novel features disclosed herein.

What is claimed is:

1. A computer implemented method of enabling an advertiser to enhance at least one of sales and profits of at least one of a company, brand, and product, comprising:
determining a size of an advertising budget; and
optimally allocating said advertising budget among one or more (a) media channels, (b) operators within any given media channel, (c) program/page provided by any given operator, and (d) space within any given program/page.

2. A system of enabling an advertiser to enhance at least one of sales and profits of at least one of a company, brand, and product, comprising:
means for optimally allocating an advertising budget among one or more (a) media channels, (b) operators within any given media channel, (c) program/page provided by any given operator, and (d) space within any given program/page.

3. The system of claim 2, further comprising:
determining a size of said advertising budget.

4. A computer program product comprising a computer usable medium having computer program logic recorded thereon for enabling a processor to enhance at least one of sales and profits of at least one of a company, brand, and product, the computer program logic comprising:
first means for enabling said processor to determine a size of an advertising budget; and
second means for enabling said processor to optimally allocate said advertising budget among one or more (a) media channels, (b) operators within any given media channel, (c) program/page provided by any given operator, and (d) space within any given program/page.
